(19) United States
(12) Patent Application Publication
(10) Pub. No.: US 2022/0284362 A1
(43) Pub. Date: Sep. 8, 2022

(54) ORGANIZATIONAL GRAPH WITH IMPLICITLY AND EXPLICITLY DEFINED EDGES

(71) Applicant: Microsoft Technology Licensing, LLC, Redmond, WA (US)

(72) Inventors: Kevin David BELLINGER, Oslo (NO); Kjetil Krogvig BERGSTRAND, Kolbotn (NO); Bernt LERVIK, Oslo (NO)

(21) Appl. No.: 17/190,230

(22) Filed: Mar. 2, 2021

(51) Int. Cl. G06Q 10/06

(52) U.S. Cl. CPC G06Q 10/06311

(57) ABSTRACT

In non-limiting examples of the present disclosure, systems, methods and devices for maintaining and interacting with organizational graphs are presented. An organizational graph comprised of nodes including relationship edges may be maintained. The edges may be traversable from one node to another via the relationship data they are defined by. New relationships may be automatically identified amongst organizational entities, and an organizational graph may be automatically updated to reflect those new relationships. An organizational graph may also be updated to reflect organizational relationships that are determined to have been modified and organizational relationships that are determined to no longer exist. User queries may be processed against an organizational graph to identify relevant nodes and their corresponding organizational relationship data.

### BACKGROUND

It is useful for large organizations to have the ability to view their employees and employees' relationships with one another in a diagramed form via computer programs and graphical user interfaces. These types of diagrams are generally called “organizational charts”. However, large organizations operate in clusters of teams and groups that defy the traditional manager/reportee structure that solutions for organizational charts typically provide. The hierarchical nature of the existing organizational chart solutions makes it difficult to quickly and efficiently identify organizational relationships that are not directly linear in hierarchical role, and that may have more to do with teams or projects than with organizational position.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for maintaining, updating, and traversing organizational graphs. According to a first example, a computer-implemented method is provided. The computer-implemented method comprises maintaining an organizational graph comprising: a first user node comprising an identity of a first user account of a first member of an organization, and a first plurality of edges, wherein each of the first plurality of edges provides a traversable relationship between the first user node and at least one other node of the organizational graph; and a second user node comprising an identity of a second user account of a second member of the organization, and a second plurality of edges, wherein each of the second plurality of edges provides a traversable relationship between the second user node and at least one other node of the organizational graph; analyzing a plurality of electronic communications between the first user account and the second user account; determining, based on the analysis, that a threshold relationship value has been met for a specific organizational relationship type of a plurality of organizational relationship types; and generating, in the first user node based at least on the determination, a new edge of the organizational graph, wherein the new edge is associated with the specific organizational relationship type and is traversable to the second user node.

According to an additional example a system for generating a new edge in an organizational graph is provided. The system comprises a memory for storing executable program code; and a processor, functionally coupled to the memory, the processor being responsive to computer-executable instructions contained in the program code and operative to: maintain the organizational graph, the organizational graph comprising: a first user node comprising an identity of a first user account of a first member of an organization, and a first plurality of edges, wherein each of the first plurality of edges provides a traversable relationship between the first user node and at least one other node of the organizational graph; and a second user node comprising an identity of a second user account of a second member of the organization, and a second plurality of edges, wherein each of the second plurality of edges provides a traversable relationship between the second user node and at least one other node of the organizational graph; analyze a plurality of electronic communications between the first user account and the second user account; determine, based on the analysis, that a threshold relationship value has been met for a specific organizational relationship type of a plurality of organizational relationship types; and generate, in the first user node based at least on the determination, a new edge of the organizational graph, wherein the new edge is associated with the specific organizational relationship type and is traversable to the second user node.

In another example, a computer-readable storage device is provided. The computer-readable storage device comprises executable instructions, that when executed by a processor, assist with generating a new edge in an organizational graph, the computer-readable storage device including instructions executable by the processor for: maintaining the organizational graph, the organizational graph comprising: a first user node comprising an identity of a first user account of a first member of an organization, and a first plurality of edges, wherein each of the first plurality of edges provides a traversable relationship between the first node and at least one other node of the organizational graph; and a second user node comprising an identity of a second user account of a second member of the organization, and a second plurality of edges, wherein each of the second plurality of edges provides a traversable relationship between the second user node and at least one other node of the organizational graph; receiving a user input to generate a new edge between the first user node and the second user node, wherein the user input comprises an indication of a specific organizational relationship type of a plurality of organizational relationship types; and generating, in the first user node based on the user input, a new edge of the organizational graph, wherein the new edge is associated with the specific organizational relationship type and is traversable to the second user node.

### BRIEF DESCRIPTION OF THE DRAWINGS

Non-limiting and non-exhaustive examples are described with reference to the following figures:

FIG. 1 is a schematic diagram illustrating an example distributed computing environment 100 for updating an organizational graph to include an implicitly identified new edge.

FIG. 2A illustrates a block diagram of an exemplary distributed computing environment for generating scores, utilizing machine learning and natural language processing engines, which may be used to determine whether a new edge should be added to an organizational graph.

FIG. 2B is a method for adding an edge corresponding to a relationship type to at least one node in an organizational graph.

FIG. 3 illustrates a block diagram of a specific team portion of an organizational graph.

FIG. 4A illustrates a block diagram of an exemplary computing environment for processing a natural language query by an organizational graph service in relation to the specific team portion of the organizational graph of FIG. 3.

FIG. 4B is a block diagram illustrating an entity relationship structure of an organizational graph, including nodes and their traversable edges.

FIG. 5 illustrates an exemplary graphical user interface for graphically traversing the specific team portion of the organizational graph of FIG. 3.

FIG. 6 illustrates a block diagram of a client portion of an organizational graph.

FIG. 7 illustrates a block diagram of an exemplary computing environment for processing a natural language query by an organizational graph service in relation to the client portion of the organizational graph of FIG. 6.

FIG. 8 illustrates an exemplary graphical user interface for graphically traversing the client portion of the organizational graph of FIG. 6.

FIG. 9A is an exemplary method for generating a new implicitly identified edge in an organizational graph.

FIG. 9B is an exemplary method for traversing an organizational graph.

FIG. 9C is an exemplary method for generating a new edge in an organizational graph based receiving explicit user input.

FIG. 9D is an exemplary method for deleting an edge from an organizational graph based on determining that a relationship no longer exists between members of an organization or has substantially declined.

FIG. 9E is an exemplary method for updating an edge of an organizational graph based on determining that a relationship between members of an organization has been modified.

FIGS. 10 and 11 are simplified diagrams of a mobile computing device with which aspects of the disclosure may be practiced.

FIG. 12 is a block diagram illustrating example physical components of a computing device with which aspects of the disclosure may be practiced.

FIG. 13 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Examples of the disclosure provide systems, methods, and devices for maintaining, updating, and traversing organizational graphs. An organizational graph service may maintain an organizational graph for an organization. The organizational graph may be comprised of user nodes and group nodes. The user nodes may represent members (e.g., employees) of the organization, and the group nodes may represent teams, projects, clients, positions, or other organizational relationship types. Each node in the organizational graph may include at least one edge. As described herein, an edge defines a relationship type between users and/or groups in an organization. Each edge in a node may be traversable to at least one other node in the organizational graph. For example, an edge of a first user node that defines a specific team of an organization may be traversable to an edge of a second user node that also defines that specific team of the organization. Similarly, an edge of a user node that defines a project for a specific client of an organization may be traversable to an edge of a group node corresponding to that specific client, as well as to an edge of a group node corresponding to that project.

The organizational graph service may automatically generate new edges for nodes of an organizational graph, update existing edges for nodes of an existing graph, and/or delete existing edges for nodes of an existing graph. For example, the organizational graph service may identify new organizational relationships amongst organizational members and/or user accounts, determine that existing relationships have been modified, and/or determine that previously existing relationships no longer exist or have substantially declined. The organizational graph service may subsequently modify a corresponding organizational graph based on these determinations. In making these determinations, the organizational graph service may analyze electronic communications amongst an organization's members and/or user accounts, as well as the content of electronic documents interacted with by organization members (e.g., interaction via the user accounts).

As described herein, an electronic document may comprise any electronic file generated by a software application that a user may input data into. Examples of electronic documents include word processing documents, spreadsheet documents, presentation documents, notes documents, electronic messages (e.g., emails, instant messages), or any other electronic file generated by a software application that a user has input data into. As described herein, an electronic communication may comprise an electronic transfer of data (e.g., via a network) from at least one user account and/or computing device to at least one other user account and/or computing device. Thus, an electronic communication may comprise an electronic transfer of an electronic document from a first user account and a first computing device to one or more additional user accounts and/or additional computing devices. Additionally, as described herein analysis of an electronic communication by the organizational graph service may comprise analysis of the electronic communication itself (e.g., what user account sent the communication, what computing device sent the communication, what user account was the communication sent to, what computing device was the communication sent to, what time was the communication sent) and/or analysis of an electronic document sent via the electronic communication.

Machine learning models that have been trained to group or otherwise classify organizational members based on frequency of communication with one another, recency of communication with one another, type of communication with one another, and/or substance of communication with one another, may be applied to electronic communications between user accounts of an organization. A machine learning model may assign a score to one or more organizational members (e.g., user accounts of organizational members) corresponding to an organizational relationship type. If that score meets or exceeds a minimum threshold relationship value, a new edge defining that organizational relationship may be added to corresponding nodes in the organizational graph. In additional examples, the machine learning models may be utilized to determine that existing organizational relationships have been modified, that they no longer exist, or that they have substantially declined based on frequency of communications, recency of communications, type of communications, and/or substance of communications. In such examples, the organizational graph service may modify or delete edges for the nodes for which those determinations were made.

One or more natural language processing and/or machine learning models may be applied to the substance of electronic communications and/or electronic documents interacted with by organizational members. The machine learning models may comprise one or more language vector embedding models (e.g., Bidirectional Encoder Representations from Transformers (BERT), Embeddings from Language Models (ELMo)). In other examples, the machine learning models may comprise a recurrent neural network (RNN) model, a long short-term memory (LSTM) model, and/or a gated recurrent units (GRU) model. In some examples a nearest neighbor model (e.g., KNN) may be utilized to determine similarity scores between embeddings (e.g., textual embeddings from electronic documents or meeting transcriptions). The natural language processing and/or machine learning models may classify communications and/or documents as relating to one or more organizational relationship types (e.g., project type, client type, team type). If one or more of the natural language processing and/or machine learning models determines that one or more communications or documents interacted with by an organizational member or group of members has a high enough score (e.g., greater than a threshold value) in relation to an organizational relationship type, a new edge defining that organizational relationship may be added to corresponding nodes in the organizational graph. In additional examples, the natural language processing and/or machine learning models may be utilized to determine that existing organizational relationships have been modified, that they no longer exist, or that they have substantially declined based on electronic document and/or electronic communication classifications. In such examples, the organizational graph service may modify or delete edges for the nodes for which those determinations were made.

The organizational graph service may make an implicit determination that a new edge should be added to a node, that an existing edge should be updated in a node, or that an existing edge should be deleted from a node. As described herein, an implicit determination refers to an automated determination made by the organizational graph service via application of one or more statistical models, natural language processing models, and/or artificial intelligence models, to data (e.g., electronic communication data, electronic document data) associated with organizational members or organizational member accounts. If the organizational graph service makes an implicit determination that a new edge should be added to a node, that an existing edge should be updated in a node, or that an existing edge should be deleted from a node, the organizational graph service may send a notification to one or more members of the organization prior to performing such an action. In some examples, the organizational graph service may only perform such an organizational graph update if those one or more members confirm that such a change should be made. In some examples, only members of an organization that have administrative rights and/or permissions associated with the organization or organizational graph service may confirm that changes to the organizational graph are to be made.

The organizational graph service may also receive explicit user input (e.g., from an administrative user such as a human resources manager or a team leader) to generate new edges for nodes of an organizational graph, update existing edges for nodes of an existing graph, and/or delete existing edges for nodes of an existing graph. In some examples, members of an organization may create custom organizational relationships that may be applied to nodes in an organizational graph as traversable edges. The statistical, natural language processing and/or machine learning models discussed above may be trained to identify custom relationships and classify organizational members and electronic documents and electronic communications into those custom relationships.

The organizational graphs described herein, and the edges of the nodes represented in those graphs, may be traversable via natural language queries and graphical navigation, among other techniques. Keyword and phrase matching models may be utilized to process natural language user queries and match them to one or more nodes or node types. Information corresponding to one or more highest ranked nodes or node types may then be surfaced. Similarly, an organizational graph application may display nodes of an organizational graph, as well as relationship edges that connect those nodes, and a user may navigate amongst the different nodes. In some examples, a user may select an edge of a node in an organizational graph with a specific relationship type and the organizational graph service may process that selection as a query to identify one or more additional nodes in the organizational graph that include an edge having that same relationship type. Those one or more additional nodes may be surfaced via a graphical user interface in response to the selection and identification.

The organizational graph service may include privacy settings that allow members of an organization to specify which personal or organizational information relating to themselves, if any, they would like to provide to the organizational service, and/or which personal or organizational information relating to themselves, if any, they would like other members of the organization (or outside the organization) to have access to via the organizational graph service. In some examples, organizational members may utilize privacy settings of the organizational service to limit the sharing of their information to specific other organizational members and/or organizational groups. In some examples, members of an organization may only have their information shared with the organizational graph service if they explicitly opt into sharing their information with the organizational graph service. In additional examples, members of an organization may opt out of sharing their information with the organizational graph service via one or more prompts or privacy settings.

The systems, methods, and devices described herein provide technical advantages for modifying, updating, and traversing organizational graphs. The mechanisms described herein reduce processing costs (e.g., CPU cycles) that are necessary to identify relevant organizational members, organizational groups, and other organizational relationships by matching natural language queries to a graph data structure comprising nodes that include relevant relationship data that can be matched to user queries. Rather than scrolling through hierarchical role structures one graphical user interface refresh after another as was the case with previous solutions, the current systems match user queries to nodes in an organizational graph data structure, where the nodes host relevant information comprised of unique edge relationships. In some examples, processing costs are further reduced in that a two layered approach may be taken in relation to processing user queries. A first layer comprised of intent classification models may be applied to identify one or more intents of a query, and a second layer of keyword and phrase matching models may only be applied to a subset of nodes that meet the identified intents, thereby eliminating the need to iteratively apply the keyword and phrase matching models to every node in a graph. The administrative user experience associated with modifying and updating large corporation organizational graphs is also enhanced in that natural language processing and/or machine learning models may be applied to electronic communication data and electronic documents, to automatically identify new relationships, determine when existing relationships have been modified, and determine when existing relationships no longer exist or have substantially declined. Utilizing these determinations, the organizational graph service can automatically propose updates to an organizational graph, thereby significantly reducing the amount of time needed to be spent by administrative users, such as human resources and information technology employees, in updating organizational graphs when changes are made in an organization.

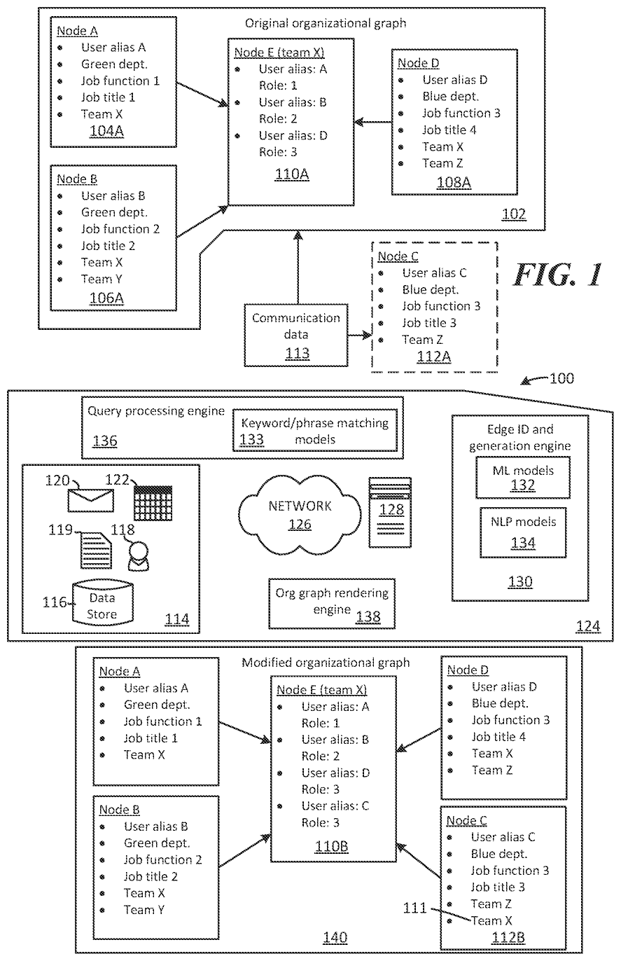

FIG. 1 is a schematic diagram illustrating an example distributed computing environment 100 for updating an organizational graph to include an implicitly identified new edge. Computing environment 100 includes original team portion 102 of an organizational graph, communication data 113, node C 112A having a newly identified edge, network and processing sub-environment 124, and modified team portion 140 of the organizational graph.

Network and processing sub-environment 124 includes network 126 and server computing device 128. All of the computing devices described herein may communicate via a network, such as network 126 in network and processing sub-environment 124. Network and processing sub-environment 124 may comprise an organizational graph service. That is, an organizational graph service may be hosted by one or more server computing devices, such as server computing device 128. The organizational graph service may maintain and modify organizational graphs, including nodes in organizational graphs and traversable edges for the nodes. In this example, network and processing sub-environment also includes data sources sub-environment 114, query processing engine 136, organizational graph rendering engine 138, and edge ID and generation engine 130. In some examples, one or more of these components may be included in or otherwise associated with the organizational graph service. Alternatively or additionally, one or more of those components may be included in or otherwise associated with one or more other services (e.g., a productivity application service, an email service, an electronic calendar service, a customer relationship management service). Although the organizational graph service and the organizational graph application are primarily described herein as being cloud based, it should be understood that one or more components of the organizational graph service and/or the organizational graph service may be executed on a local computing device.

The organizational graph service may communicate with one or more data sources as illustrated by data sources sub-environment 114. Data sources sub-environment 114 includes data store 116, electronic documents 119, user information 118, electronic messages 120, and electronic calendar information 122. Data sources sub-environment 114 may include more or fewer data sources than those illustrated and described in relation to FIG. 1. Data store 116 is representative of various data sources. Data store 116 may comprise data associated with organizational user accounts. For example, data store 116 may comprise data for a plurality of user accounts for an organization, where the user accounts are associated with one or more computing devices, one or more applications (e.g., productivity applications), and/or one or more application suites (e.g., productivity application suites). For example, one or more users may each have a user account that is associated with one or more applications and/or services and data that includes settings, preferences, and/or electronic documents associated with that user account, all of which may be included in data store 116 with user information 118. Thus, in this example, data store 116 may include user information 118, electronic documents 119, emails 120, and electronic calendar information 122 (or references thereto) associated with one or more user accounts. Electronic documents 119 may comprise word processing documents, spreadsheet documents, presentation documents, notes documents, electronic messages (e.g., emails, instant messages), or any other productivity application documents.

The organizational graph service may maintain original team portion 102 of an organizational graph. That is, original team portion 102 comprises a plurality of nodes that are all related to a team of an organization. The organizational graph service may maintain an organizational graph for that organization that includes additional nodes that are related to other teams, clients, projects, and other relationship types. Original team portion 102 of the organizational graph includes node A 104A, node B 106A, node D 108A, and node E 110A. Nodes in an organizational graph may each have one or more types associated with them. For example, a node may be associated with a user type (e.g., a node may represent a single employee of an organization), a team type (e.g., a node may represent one or more employees of an organization that are all assigned or otherwise associated with a particular team of the organization), a client type (e.g., a node may represent a client that an organization works with), and/or another organizational relationship type.

Each node included in original team portion 102 of the organizational graph includes a plurality of edges, with each edge comprising relationship data indicating a type of organizational relationship that a node is associated with. The relationship data may be queried via a natural language input to identify relevant nodes and their associated edges and connections. Each edge may be traversed by the organizational graph service to one or more other nodes in an organizational graph that include same or related edges and corresponding relationship data (e.g., a different node with an edge of a same relationship type). In additional examples, nodes of an organizational graph may be graphically displayed and graphically traversed via edges, which may also be graphically displayed. Each of the nodes included in original team portion 102 of the organizational graph, and the edges included in those nodes, may have been manually generated (e.g., via explicit user input to the organizational service) or automatically generated (e.g., via implicit identification of relationships) by the organizational graph service.

Node A 104A is a user node and it includes an identity of a user account (user alias A) of a member of the organization for which the organizational graph is maintained, a department of the organization that the member works in (green department), a job function of the member (job function 2), a job title of the member (job title 1), and a team of the organization that the member is assigned to (team X). Each of these pieces of information may comprise an edge that is traversable to one or more other nodes in the organizational graph.

Node B 106A is a user node and it includes an identity of a user account (user alias B) of a member of the organization for which the organizational graph is maintained, a department of the organization that the member works in (green department), a job function of the member (job function 2), a job title of the member (job title 2), a first team of the organization that the member is assigned to (team X) and a second team of the organization that the member is assigned to (team Y). Each of these pieces of information may comprise an edge that is traversable to one or more other nodes in the organizational graph.

Node D 108A is a user node and it includes an identity of a user account (user alias D) of a member of the organization for which the organizational graph is maintained, a department of the organization that the member works in (blue department), a job function of the member (job function 3), a job title of the member (job title 4), a first team of the organization that the member is assigned to (team X), and a second team of the organization that the member is assigned to (Team Z). Each of these pieces of information may comprise an edge that is traversable to one or more nodes in the organizational graph.

Node E 110A is a team node corresponding to team X of the organization for which the organizational graph is maintained. Node E 110A includes identities of members and/or user accounts that are assigned to team X, as well as the roles of those members. Thus, in this example, node E 110A includes user alias A corresponding to node A 104A, and role 1 corresponding to the job function of that member; user alias B corresponding to node B 106A, and role 2 corresponding to the job function of that member; and user alias D corresponding to node D 108A, and role 3 corresponding to the job function of that member. Each of these pieces of information may comprise an edge that is traversable to one or more nodes in the organizational graph. Although in this example each member is illustrated and described as being associated with a single role (e.g., a job function), members may have other and/or additional role types that may be included in corresponding nodes in an organizational graph. For example, a member may have a first job function role of “manager” and a second team type role of “member”. Additionally, the one or more roles that are included in a group node for a member with more than one role type may differ based on the one or more role types of the member that apply to that group node (e.g., a member may have a “manager” role type in relation to a first group, but only a “member” role type in relation to a second group).

The organizational graph service may analyze organizational data to determine whether new nodes should be generated and whether existing nodes and their edges should be updated or deleted. Those determinations may be made periodically (e.g., every 24 hours, every week), based on triggering events (e.g., when X number of electronic communications are made between user accounts, when a node is manually added to an organizational graph), and/or based on manual input (e.g., organizational preferences or settings). In this example, Node C 112A is an existing node in the organizational graph. However, the edges included in Node C 112A are not directly traversable to Node E 110A in the original team portion 102 of the organizational graph. That is, there is not a single traversable edge that directly links Node C 112A to Node E 110A (e.g., because user alias C represented by Node C has not previously been identified as a member of team X represented by Node E).

In determining whether to generate a new node, update an existing node and its edges, or delete an existing node and its edges, the organizational graph service may process data associated with one or more user accounts of the organization. That data may be stored in data store 116. The processing of the data to determine whether to generate a new node, update an existing node and its edges, or delete an existing node and its edges, may be performed by edge ID and generation engine 130, which includes machine learning models 132 and natural language processing models 134.

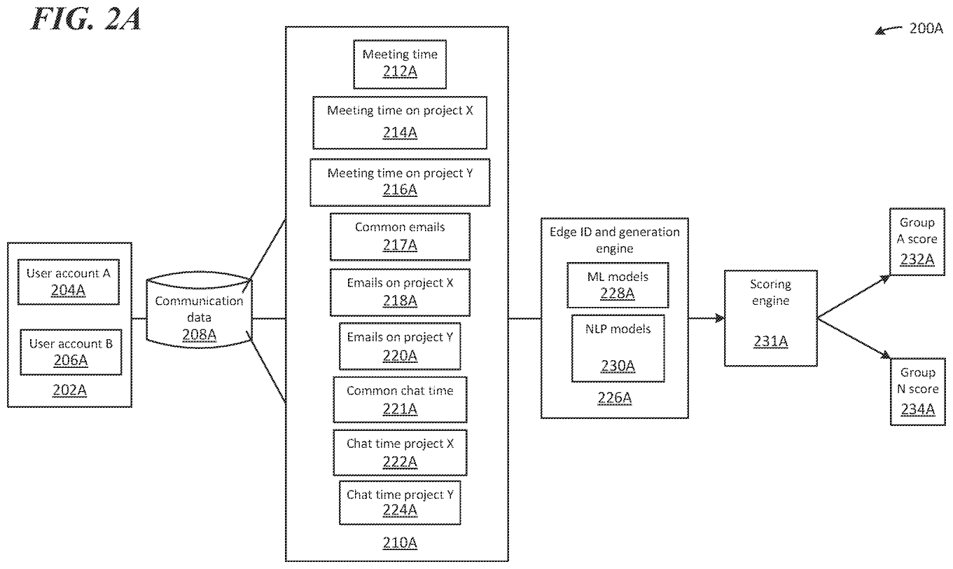

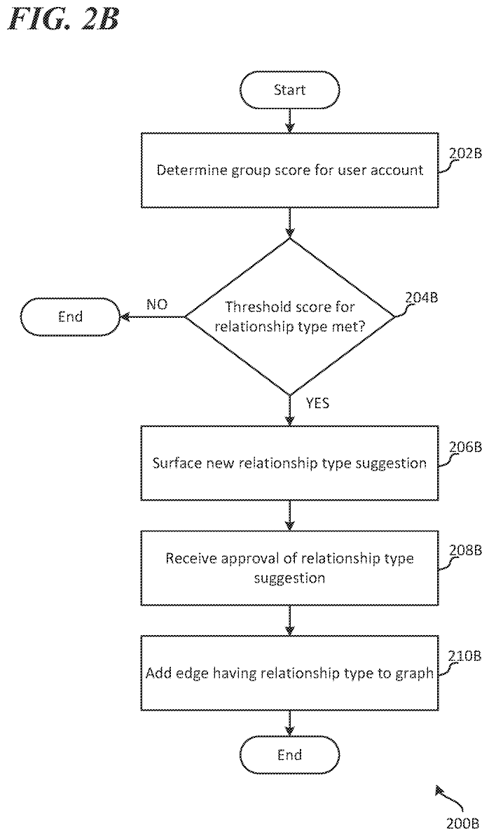

The organizational graph service may analyze frequency of electronic communications between user accounts, recency of communications between user accounts, duration of electronic communications between user accounts, content of electronic communications between user accounts, and/or other relevant factors to determine whether a new edge should be created between corresponding user nodes, or whether an existing edge should be updated or deleted. In additional examples, the organizational graph service may analyze and classify the content of electronic communications and/or the content of electronic documents generated or received by one or more user accounts to determine whether a new relationship type should be added to a node that may be utilized as a traversable edge to one or more other nodes in an organizational graph. In still additional examples, the organizational graph service may analyze and classify the content of electronic communications and/or the content of electronic documents generated or received by one or more user accounts to determine whether existing relationship types should be updated or removed from a node. Additional details related to edge ID and generation engine 130 are provided below in relation to FIG. 2A.

In this example, the organizational graph service may process electronic document and/or electronic communication data associated with the user account corresponding to node C 112A, and determine that the member of the organization corresponding to that user account is also a member of team X. For example, the organizational graph service may apply natural language processing models 134 to documents generated by the user account corresponding to node C 112A, sent to other user accounts in the organization by the user account corresponding to node C 112A, or sent to the user account corresponding to node C 112A from other user accounts in the organization, and determine based on the classification of those documents and/or the frequency, recency, or duration of communications with other members of the organization on team X, that a score for the member of the organization corresponding to node C 112A meets or exceeds a threshold relationship value for team X. A likelihood that [user alias C] is a member of team X (e.g., based on the frequency, recency, or duration of communications with other members on team X) may be determined based on application of machine learning models 132 to the electronic communications. In some examples a first score may be determined based on the classification of content of electronic communications and/or electronic documents via application of natural language processing models 134, and a second score may be determined based on the frequency, recency, or duration of electronic communications and/or electronic document interactions with other members on team X via application of machine learning models 132.

Upon determining that the member of the organization corresponding to node C 112A is also a member of team X (e.g., to a threshold degree of likelihood), the organizational graph service may update node C 112A to include a new edge. The new edge may correspond to data in node C 112A indicating that user alias C is a member of team X. In other examples, upon determining that the member of the organization corresponding to node C 112A meets or exceeds a threshold relationship value for team X, the organizational graph service may cause a notification to be surfaced or sent to the user account corresponding to node C 112A, one or more other user accounts of members of team X (e.g., a manager or supervisor of team X), and/or an administrative user (e.g., HR representative) that requires confirmation of user alias C's determined membership in team X before node C 112A is updated with that information. The updated graph and node are illustrated by modified team portion 140 of the organizational graph and node C 112B, which now includes new edge 111, which is directly traversable to node E 110B.

Once node C 112B is updated, the content of new edge 111 may be queried via natural language inputs and/or graphically traversed from node C 112A to node E 110A. For example, the organizational graph service may process natural language user queries received from an organizational graph service application via query processing engine 136. Queries may be received by the organizational graph service via various input mechanisms (e.g., typed input, audio input, input to menus or lists). Query processing engine 136 may comprise keyword or phrase matching models 133 that are utilized to score one or more nodes in an organizational graph based on their relevance to a natural language input. Upon processing a natural language query via query processing engine 136, the organizational graph service may cause one or more top ranked nodes, and one or more surrounding nodes, in an organizational graph to be surfaced on a graphical user interface rendered by organizational graph rendering engine 138. The surfaced graph may then be traversed by a user (e.g., an organization member) via the graphical user interface via displayed nodes and their corresponding edges.

FIG. 2A illustrates a block diagram of an exemplary distributed computing environment 200A for generating scores, utilizing machine learning and natural language processing engines, which may be used to determine whether a new edge should be added to an organizational graph. Distributed computing environment 200A includes user accounts 202A, communication data store 208A, communication data 210A, edge ID and generation engine 226A, scoring engine 231A, group A score 232A, and group N score 234A.

User accounts 202A include user account A 204A and user account B 206A, which are illustrative of two user accounts associated with an organization (e.g., members/employees of the organization) for which the organizational graph service maintains an organizational graph. Electronic documents, electronic communications, and other data associated with user accounts 202A may be stored in a data store, such as communication data store 208A. In this example, communication data store includes communication data 210A, which comprises meeting time 212A, meeting time on project X 214A, meeting time on project Y 216A, joint emails 217A, emails on project X 218A, emails on project Y 220A, common chat time 221A, chat time on project X 222A, and chat time on project Y 224A. In some examples, the organizational graph service may classify electronic communications and/or electronic documents included in or linked by electronic communications and generate summary data associated with those communications (e.g., analyze a plurality of meetings to determine a total amount of time spent by users in them, analyze a plurality of emails to determine a total number sent on a particular topic).

Meeting time 212A may correspond to a total duration of time that user account A 204A and user account B 206A were in electronic meetings together over a specific period of time (e.g., last month, last year). Meeting time on project X 214A may correspond to a total duration of time that user account A 204A and/or user account B 206A were in meetings related to a first specific project (e.g., project X). Meeting time on project Y 216A may correspond to a total duration of time that user account A 204A and/or user account B 206A were in meetings related to a second specific project (e.g., project Y). Common emails 217A may correspond to all emails that jointly included user account A 204A and user account B over a specific period of time (e.g., last month, last year). Emails on project X 218A may correspond to a total number of emails about a first specific project (e.g., project X) that were sent between user account A 204A and user account B 206A and/or a total number of emails about a first specific project (e.g., project X) that included user account A 204A and/or user account B 206A. Emails on project Y 220A may correspond to a total number of emails about a second specific project (e.g., project Y) that were sent between user account A 204A and user account B 206A and/or a total number of emails about a second specific project (project Y) that included user account A 204A and/or user account B 206A. Common chat time 221A may correspond to a total amount of time that user A 204A and user B 206A spent in electronic chats with one another over a specific period of time (e.g., last month, last year), or a total amount of content that was exchanged in electronic chats between user A 204A and user B 206A over a specific period of time (e.g., last month, last year). Chat time on project X 222A may correspond to a total amount of time and/or an amount of content that that was exchanged in an electronic chat application between user account A 204A and user account B 206A discussing a first specific project (e.g., project X), and/or a total amount of time and/or content that was exchanged by user account A 204A or user account B 206A in an electronic chat application discussing a first specific project (e.g., project X) with one or more other users. Chat time on project Y 224A may correspond to a total amount of time and/or an amount of textual content that was exchanged in an electronic chat application between user account A 204A and user account B 206A discussing a second specific project (e.g., project Y), and/or a total amount of time and/or content that was exchanged by user account A 204A or user account B 206A in an electronic chat application discussing a second specific project (e.g., project Y) with one or more other users.

The organizational graph service may apply one or more machine learning and/or natural language processing models to classify meeting content, email content, chat application content, electronic document content, or other communication data as being related to a specific project, group, client, or topic. For example, the organizational graph service may transcribe audio data from an electronic meeting and apply a machine learning model to the transcribed text to classify the text as being related to one or more topics or one or more projects. In some examples, the machine learning model may comprise a neural network or a vector embedding model. In additional examples, the organizational graph service may process and topically classify the content of electronic documents attached to or linked by a meeting invite to determine whether an electronic meeting relates to a specific project. The processing of communication data 210A may be performed by edge ID and generation engine 226A, which comprises machine learning models 228A and natural language processing models 230A. In some examples, a relevance of communication data 210A and/or summaries (e.g., determined durations of time spent on projects, determined amount of content exchanged on projects) of communication data 210A to one or more organizational relationships may be determined based on the classifications described above.

Based on the processing of communication data 210A performed by edge ID and generation engine 226A, group A score 232A may be determined by scoring engine 231A. Group A score 232A may correspond to a likelihood that user account A 204A and/or user account B 206A are members of an organization that belong to group A. Similarly, based on the processing of communication data 210A performed by edge ID and generation engine 226A, group N score 234A may be determined by scoring engine 231A. Group N score 234A may correspond to a likelihood that user account A 204A and/or user account B 206A are members of an organization that belong to group N. For example, one or both of group A and group N of the organization may largely be responsible for project Y or project X, and more time spent communicating on issues related to one of those projects may relate to a higher likelihood of an organization member belonging to group A or group N. Additionally, user account A 204A or user account B 206A may already be associated with a node that belongs to group A or group N. Thus, if another user account communicates with that user account, there may be a higher likelihood that the corresponding member also belongs to group A or group N.

The organizational graph service may determine whether one or more edges should be added to an organizational graph in association with user account A 204A and/or user account B 206A based on group A score 232A and group N score 234A, as more fully discussed below in relation to FIG. 2B.

FIG. 2B is a method for adding an edge corresponding to a relationship type to at least one node in an organizational graph. The method 200B begins at a start operation and flow moves to operation 202B.

At operation 202B a group score for a user account is determined. The group score may correspond to a likelihood that a member of an organization is also a member of a specific group (e.g., project group, team group, client servicing group) of the organization. In examples, the group score may be determined by scoring engine 231A. For example, scoring engine 231A may receive classification data from edge ID and generation engine 226A, and or summary data (e.g., determined durations of time spent on projects, determined amount of content exchanged on projects) for the user account (e.g., user account A 204A, user account B 206A), and generate a score corresponding to a likelihood that the member associated with that user account is a member of the specific group. As an example, the score may be in a range from 0 to 1, with 0 corresponding to no likelihood that the member of the organization is a member of the specific group, and 1 corresponding to a near certainty that the member of the organization is a member of the specific group. In other examples, other scoring values or value types (e.g., 0 to 100, percentages, ratios) corresponding to a likelihood of group membership may be generated by the scoring engine.

From operation 202B flow continues to operation 204B. At operation 204B a determination is made as to whether the determined group score for the user account meets or exceeds a threshold value for an organizational relationship type. The threshold value at operation 204B is utilized to determine whether a node corresponding to the user account should be modified to include a new relationship edge corresponding to the group for which the group score was determined. If at operation 204B a determination is made that the determined group score for the user account does not meet or exceed the threshold value for the organizational relationship type, flow moves to an end operation. Alternatively, if at operation 204B a determination is made that the determined group score for the user account does meet or exceed the threshold value for the organizational relationship type, flow moves to operation 206B.

At operation 206B the organizational graph service surfaces a new relationship type suggestion. The new relationship type suggestion may correspond to the organizational relationship type that the group score was determined to meet or exceed the threshold value for. The suggestion may be surfaced in a graphical organization application user interface (e.g., in a text box, in a popup window), via a message alert (e.g., email, text message), or audibly. The suggestion may be surfaced to one or more user accounts corresponding to nodes that the suggestion, if accepted, would affect. In additional examples, the suggestion may be surfaced to one or more administrator accounts of the organization. The suggestion may include a selectable option to affirmatively approve the suggestion of the relationship type in association with one or more nodes of the organizational graph. In some examples, rather than utilizing a selectable option to approve the suggestion, a user may reply (e.g., via typed input, via verbal/audio input) that the user would like to approve the suggestion. The suggestion may also include an option to deny the suggestion of the relationship type in association with one or more nodes of the organizational graph.

From operation 206B flow continues to operation 208B where the organizational graph service receives user approval of the relationship type suggestion. The approval may be received via selection of a surfaced user interface element in the organizational graph service or via a reply (e.g., typed input, verbal/audio input) to the surfaced relationship type suggestion.

From operation 208B flow continues to operation 210 B where, upon receiving the user approval, an edge having the relationship type is added to the organizational graph. The edge may be added to the node that had a determined group score that met or exceeded the threshold value for the organizational relationship type.

From operation 210B flow moves to an end operation and the method 200B ends.

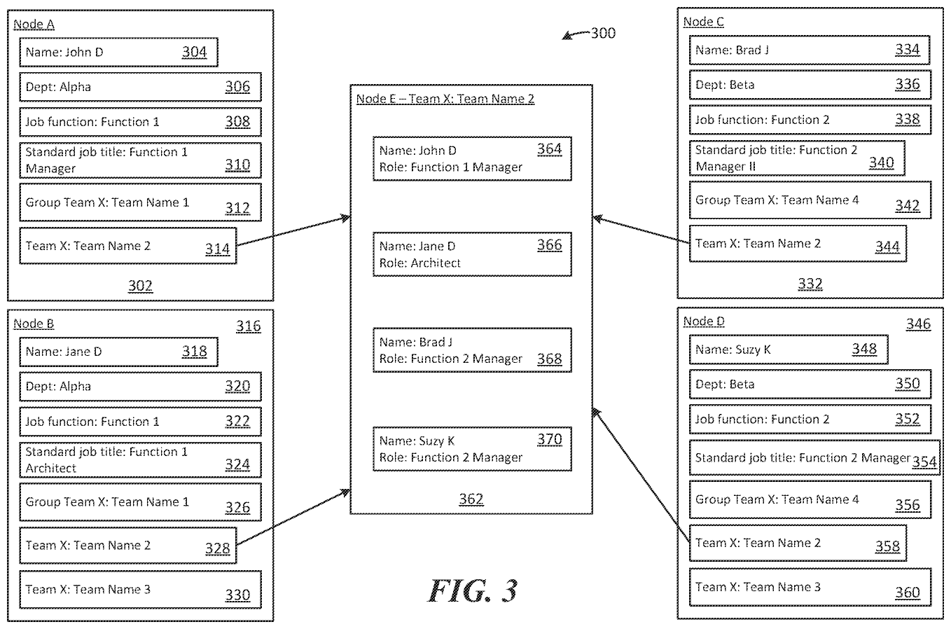

FIG. 3 illustrates a block diagram of a specific team portion 300 of an organizational graph. The specific team portion 300 of the organizational graph includes node A 302, node B 316, node C 332, node D 346, and node E 362. Thus, the specific team portion 300 of the organizational graph includes four user type nodes and one group type node (specifically a team type group node). Each of the user type nodes includes an identity of a user account of a member of the organization and a plurality of edges that are each traversable to at least one other node.

Node A 302 includes first organizational member identity 304 (“John D”). Node A 302 includes first graph edge 306, which defines the department (“Alpha”) that the first organizational member belongs to; second graph edge 308, which defines the job function (“Function 1”) for the first organizational member; third graph edge 310, which defines the standard job title (“Function 1 Manager”) for the first organizational member; fourth graph edge 312, which defines a first team (“Group Team X: Team Name 1”) that the first organizational member is a member of; and fifth graph edge 314, which defines a second team (“Team X: Team Name 2”), which the first organizational member is also a member of. Each of the edges included in node A 302 may be traversable to at least one other node in the organizational graph. In this example, fifth graph edge 314 is directly traversable to node E 362, as fifth graph edge 314 identifies the first member as belonging to “Team X: Team Name 2” corresponding to node E 362. Although not shown, fourth graph edge 312 may be directly traversable to another group type node (not shown) corresponding to “Group Team X: Team Name 1”. Third graph edge 310 may be directly traversable to another group type node (not shown) corresponding to a group of Function 1 Managers. Second graph edge 308 may be directly traversable to another group type node (not shown) corresponding to a group of organization members having the “Function 1” job function. First graph edge 306 may be directly traversable to another group type node (not shown) corresponding to members of the “Alpha” department.

Node B 316 includes second organizational member identity 318 (“Jane D”). Node B 316 includes sixth graph edge 320, which defines the department (“Alpha”) that the second organizational member belongs to; seventh graph edge 322, which defines the job function (“Function 1”) for the second organizational member; eighth graph edge 324, which defines the standard job title (“Function 1 Architect”) for the second organizational member; ninth graph edge 326, which defines a first team (“Group Team X: Team Name 1”) that the second organizational member is a member of; tenth graph edge 328, which defines a second team (“Team X: Team Name 2”) that the second organizational member is a member of; and eleventh graph edge 330, which defines a third team (“Team X: Team Name 3”) that the second organizational member is also a member of. Like with node A 302, each of the edges of node B 316 may be traversable to at least one other node in the organizational graph. Ninth graph edge 326 is directly traversable to node E 362, as ninth graph edge 326 identifies the second member as belonging to “Team X: Team Name 2” corresponding to node E 362. The remainder of the edges of node B 316 may also be traversable to other group type nodes that are not shown in FIG. 3 but that may be included in the organizational graph.

Node C 332 includes third organizational member identity 334 (“Brad J”). Node C 332 includes twelfth graph edge 336, which identifies the department (“Beta”) that the third organizational member belongs to; thirteenth graph edge 338, which defines the job function (“Function 2”) for the third organizational member; fourteenth graph edge 340, which defines the standard job title (“Function 2 Manager II”) for the third organizational member; fifteenth graph edge 342, which defines a first team (“Group Team X: Team Name 4”) that the third organizational member is a member of; and sixteenth graph edge 344, which defines a second team (“Team X: Team Name 2”) that the third organizational member is also a member of. Like with node A 302 and node B 316, each of the edges of node C 332 may be traversable to at least one other node in the organizational graph. Sixteenth graph edge 344 is directly traversable to node E 362, as sixteenth edge 344 identifies the third member as belonging to “Team X: Team Name 2” corresponding to node E 362. The remainder of the edges of node C 332 may also be traversable to other group type nodes that are not shown in FIG. 3 but that may be included in the organizational graph.

Node D 346 includes fourth organizational member identity 348 (“Suzy K”). Node D 346 includes seventeenth graph edge 350, which identifies the department (“Beta”) that the fourth organizational member belongs to; eighteenth graph edge 352, which defines the job function (“Function 2”) for the fourth organizational member; nineteenth graph edge 354, which defines the standard job title (“Function 2 Manager”) for the fourth organizational member; twentieth graph edge 356, which defines a first team (“Group Team X: Team Name 4”) that the fourth organizational member is a member of; twenty-first graph edge 358, which defines a second team (“Team X: Team Name 2”) that the fourth organizational member is a member of; and twenty-second graph edge 360, which defines a third team (“Team X: Team Name 3”) that the fourth organizational member is also a member of. Like with node A 302, node B 316, and node C 332, each of the edges of node D 346 may be traversable to at least one other node in the organizational graph. Twenty-first graph edge 358 identifies the fourth member as belonging to “Team X: Team Name 2” corresponding to node E 362. The remainder of the edges of node D 346 may also be traversable to other group type nodes that are not shown in FIG. 3 but that may be included in the organizational graph.

Node E 362 is the group type node for the organizational team “Team X: Team Name 2”. Node E 362 includes information from user nodes that have edges leading to it. That information may be rendered graphically as edges by the organizational graph service, which may then be graphically traversed to the corresponding user nodes and edges. The edges of node E 362 may also be queried via natural language user input into an organizational graph application. In this example, node E 362 includes first group edge 364, which defines the identity of the first organizational member (“John D”), as well as the role (“Function 1 Manager”) of the first organizational member; second group edge 366, which defines the identity of the second organizational member (“Jane D”), as well as the role (“Architect”) of the second organizational member; third group edge 368, which defines the identity of the third organizational member (“Brad J”), as well as the role (“Function 2 Manager”) of the third organizational member; and fourth group edge 370, which defines the identity of the fourth organizational member (“Suzy K”), as well as the role (“Function 2 Manager”) of the fourth organizational member.

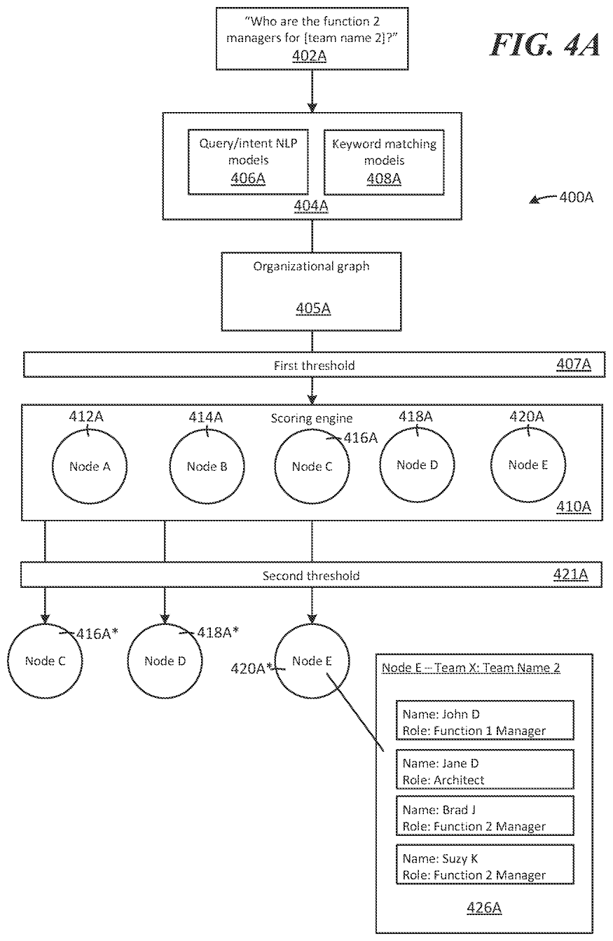

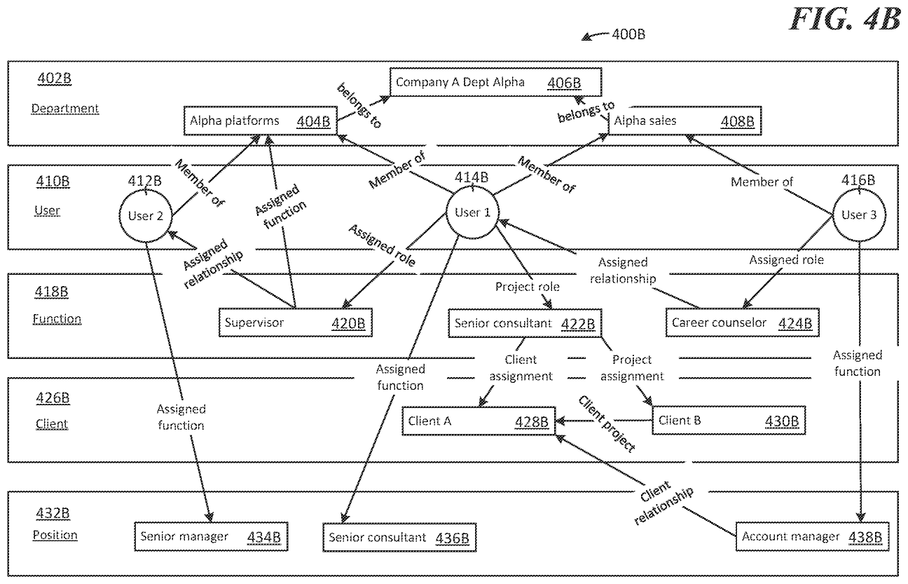

FIG. 4A illustrates a block diagram of an exemplary computing environment 400A for processing a natural language query by an organizational graph service in relation to the specific team portion of the organizational graph of FIG. 3. Computing environment 400A includes natural language user query 402A, language models 404A, organizational graph 405A, first threshold value 407A, scoring engine 410A, second threshold value 421A, and nodes for which query match scores have met or exceeded second threshold 421A. Those nodes are: node C 416A*, node D 418A*, and node E 420A*.

Natural language user query 402A includes the input: “Who are the function 2 managers for [team name 2]?” Natural language user query 402A may be received via a search interface of an organizational graph application associated with the organizational graph service. In additional examples, natural language user query 402A may be received via a different application (e.g., an email application, a contacts application) that may utilize an application programming interface (API) to tie into the organizational graph service.

Natural language user query 402A may be processed by the organizational graph service, and specifically, by one or more language models, such as language models 404A. Language models 404A include query/intent natural language processing models 406A and keyword matching models 408A, although more, fewer, and/or alternative models may be utilized by the organizational graph service to process natural language input queries. Query/intent natural language processing models 406A may comprise one or more machine learning models that have been trained to identify an intent type of queries provided to the organizational graph service. Examples of intent types that may be identified may include “identify user”, “identify users”, “identify team”, “identify teams”, and “identify client”, among others. The intent types that query/intent natural language processing models 406A have been trained to identify may correspond to node types that are included in organizational graphs. In some examples, query/intent natural language processing models 406A may comprise one or more embedding models (e.g., BERT, ELMo). In other examples, query/intent natural language processing models 406A may comprise a RNN model, a LSTM model, and/or a GRU model. In some examples a nearest neighbor model (e.g., KNN) may be utilized to determine similarity scores between embeddings.

In addition or alternative to processing natural language user query 402A with query/intent natural language processing models 406A, natural language user query 402A may be processed by one or more keyword matching models, such as keyword matching models 408A. Keyword matching models 408A may match one or more words or phrases in natural language user query 402A to one or more words or phrases in one or more nodes of organizational graph 405A. Organizational graph 405A comprises a plurality of nodes corresponding to all or a portion of an organizational graph.

A score may be generated for nodes in the organizational graph (e.g., organizational graph 405A) based on the processing performed by query/intent natural language processing models 406A and/or keyword matching models 408A. For example, a first score may be determined based on how closely an intent type identified via query/intent natural language processing models 406A matches a node type in organizational graph 405A. A second score may be determined based on how closely a keyword or phrase in natural language user query 402A matches the corresponding word or phrase in a node (e.g., in an edge of a node) in organizational graph 405A. In additional examples, if a first intent type corresponding to a node type is identified to a threshold degree of accuracy (e.g., a score for an intent type and corresponding node type meets a threshold score as determined via query/intent natural language processing models 406A), keyword matching models 408A may only be applied on natural language user query 402A to match keywords or phrases of nodes corresponding to that type. Thus, by first identifying relevant intent types and their corresponding node types, processing costs may be greatly reduced in that keyword matching models 408A need only be applied to a smaller subset of nodes and their edges.

In this example, query/intent natural language processing models 406A may have identified node A 412A (node 302 in FIG. 3), node B 414A (node 316 in FIG. 3), node C 416A (node 332 in FIG. 3), node D 418A (node 346 in FIG. 3), and node E 420A (node 362 in FIG. 3) as meeting or exceeding first threshold value 407A of similarity to an intent type of natural language user query 402A. Keyword matching models 408A may then be applied to each of these nodes as illustrated by scoring engine 410A, and a keyword or phrase matching score for each of these nodes may be determined. If the keyword or phrase matching score meets or exceeds second threshold value 421A, the nodes corresponding to that score may be surfaced or otherwise highlighted or emphasized in a graphical user interface (e.g., an organizational graph user interface) in response to the user query. Thus, in this example, the scores for node C 416A*, node 418A*, and node E 420A* meet or exceed second threshold value 421A, and those nodes, or information included in those nodes may be surfaced. A user may interact with (e.g., click with a mouse, hover a cursor over, provide touch input relative to) a node that is surfaced, and additional information included in that node may be caused to be surfaced, as illustrated by node E 420A* and corresponding additional information 426A.

FIG. 4B is a block diagram 400B illustrating an entity relationship structure of an organizational graph, including nodes and their traversable edges. Diagram 400B includes five organizational classifications, which are each representative of a node type that may be included in an organizational graph. Those five organizational classifications are department type 402B, user type 410B, function type 418B, client type 426B, and position type 432B. The organizational classifications included in diagram 400B are provided for illustrative purposes and it should be understood that other organizational classifications (e.g., team, geographic location, role) may be represented as nodes in a graph. Additionally, the systems and mechanisms described herein provide organizations and their members with the ability to define custom organizational classifications, therefore providing a flexible and extensible model for organizational users.

In this example, each of the organizational classifications include a plurality of nodes for an organizational graph, with each node including at least one edge. The edges in diagram 400B are represented by arrowed lines connecting the nodes, and a type of each edge is included in the text that overlays each of those lines. The edge types may be associated with the edges at the time that edges are created or modified in the organizational graph. The edge types may also be manually updated by an administrative account (e.g., a user with administrative rights to the organizational graph) associated with an organization. In some examples, the edge types may be associated with the edges as data or metadata and that data or metadata may be utilized in processing user queries of an organizational graph. For example, when processing a user query such as “what project is client B working on” the organizational graph service may analyze edge type metadata associated with client B node 430B and match that query (e.g., utilizing keyword or phrase matching language models) to the “client project” edge type metadata connecting client B node 430B to client A node 428B. In additional examples, the edge types may be displayed in an organizational graph application to provide an enhanced user experience when graphically traversing the graph.

Nodes of department type 402B include company A alpha node 406B, alpha platforms node 404B, and alpha sales node 408B. Nodes of user type 410B include user 2 node 412B, user 1 node 414B, and user 3 node 416B. Nodes of function type 418B include supervisor node 420B, senior consultant node 422B, and career counselor node 424B. Nodes of client type 426B include client A node 428B and client B node 430B. Nodes of position type 432B includes senior manager node 434B, senior consultant node 436B, and account manager node 438B.

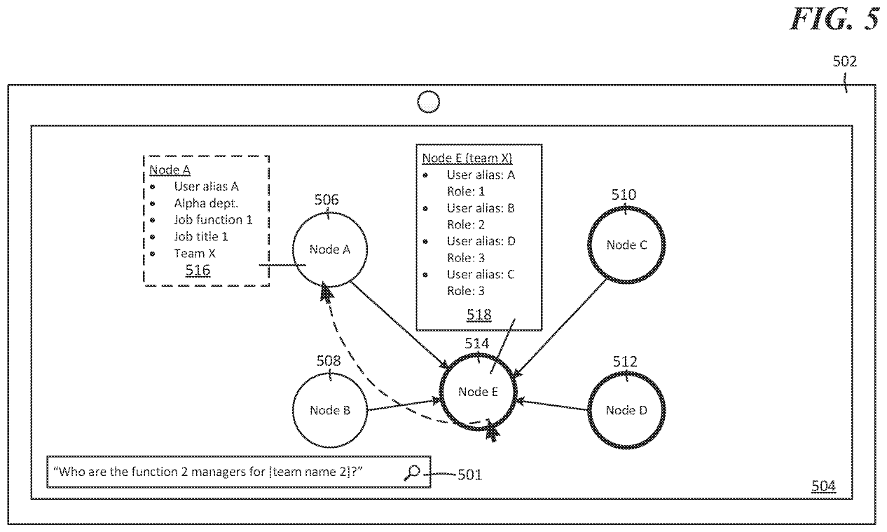

The organizational graph service may surface search results to user queries via a variety of mechanisms. In some examples, the organizational graph service may surface one or more top ranked (e.g., based on scoring described above in relation to FIG. 4A) node names (e.g., group name, user name, team name) or descriptors. For example, one or more top ranked group names, user names, and/or team names may be surfaced via a textual user interface element, an electronic message, and/or an audio output from a computing device. In some examples, the surfaced search results may be interacted with (e.g., via cursor hover, via touch input, via selection of a link, via verbal/audio input), and that interaction may cause additional information associated with an interacted with search result to be surfaced. In some examples, interaction with a search result may cause display of a graph view of one or more top ranked search results, such as illustrated in FIG. 5. In other examples, a graph view may be immediately displayed (e.g., not require interaction with a search result).

FIG. 5 illustrates an exemplary graphical user interface 504 for graphically traversing the specific team portion of the organizational graph of FIG. 3. Graphical user interface 504 is displayed on computing device 502. Graphical user interface 504 may be rendered in an organizational graph application after the organizational graph service receives and processes natural language user query 402A from FIG. 4A.

Graphical user interface 504 includes node A 506, node B 508, node C 510, and node D 512. Nodes E 514, C 510, and D 512 are graphically emphasized (e.g., bolded, highlighted, different color) on user interface 504 because they are the nodes of the specific team portion of the organizational graph that were determined to have scores that meet or exceed the second threshold value for the user query (e.g., natural language user query 402A). In this example, the search query is received via search box 501, although other query mechanisms (e.g., verbal search query, text query to digital assistant) may be utilized according to the systems and methods described herein.

In this example, a user provides input relative to node E 514 by hovering a cursor over, clicking on, or otherwise interacting with node E 514. As a result, window 518 is caused to be displayed, which provides information about the edges that are included in node E 514. Specifically, window 518 states “Node E (team X)” and “User alias: A” “Role: 1”, “User alias: B” “Role: 2”, “User alias: D” “Role 3”, “User alias: C” “Role: 3”. Another interaction is then received in relation to node A 506, which causes window 516 to be displayed. Window 516 provides information about edges that are included in node A 506. Specifically, window 516 states “Node A” and includes “User alias A”, “Alpha dept.”, “Job function 1”, “Job title 1”, and “Team X”. As discussed in relation to FIG. 3, the team information of node A 506 may be directly traversed as an edge to node E 514.

The other nodes displayed on user interface 504 may also be interacted with by a user and, in response, information associated with the nodes may be displayed in a same or similar fashion as illustrated and described in relation to node A 506 and window 516, and node E 514 and window 518.

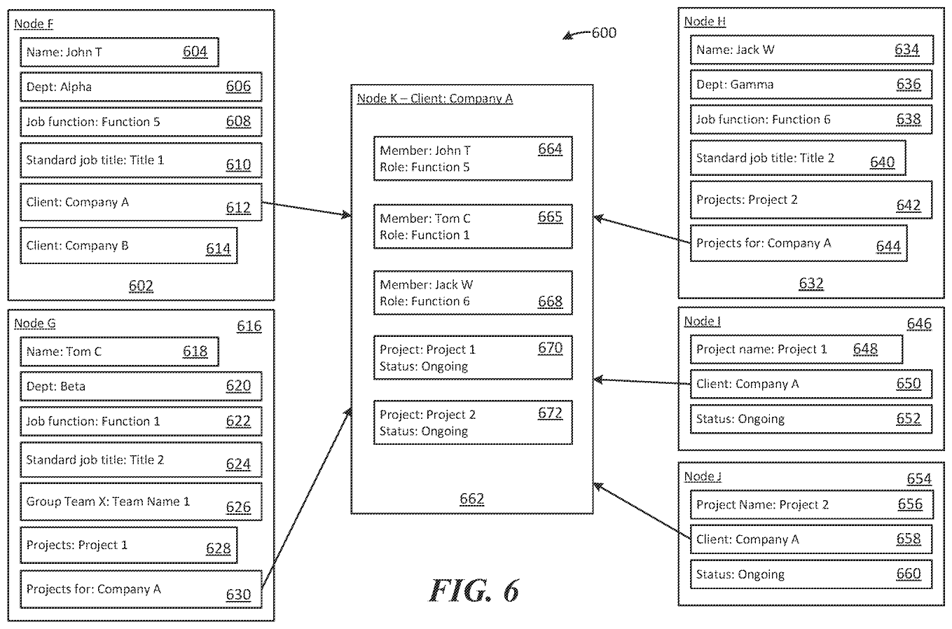

FIG. 6 illustrates a block diagram of an exemplary client portion 600 of an organizational graph. The client portion 600 of the organizational graph includes node F 602, node G 616, node H 632, node I 646, and node K 662. In the illustrated example, client portion 600 of the organizational graph includes three user type nodes (node F 602, node G 616, node H 632), one client group type node (node K 662), and two project type nodes (node I 646, node J 654). Each of the user type nodes includes an identity of a user account of a member of the organization and a plurality of edges that are each traversable to at least one other node. Each of the project type nodes includes an identity of a project of the organization and a plurality of edges that are each traversable to at least one other node.

Node F 602 includes first organizational member identity 604 (“John T”). Node F 602 includes first graph edge 606, which defines the department (“Alpha”) that the first organizational member belongs to; second graph edge 608, which defines the job function (“Function 5”) for the first organizational member; third graph edge 610, which defines the standard job title (“Title 1”) for the first organizational member; fourth graph edge 612, which defines a first client (“Company A”) that the first organizational member is assigned to, and fifth graph edge 614, which defines a second client (“Company B”) that the first organizational member is also assigned to.

Each of the edges included in node F 602 may be traversable to at least one other node in the organizational graph. In this example, fourth graph edge 612 is directly traversable to node K 662, as fourth graph edge 612 identifies the first member as being assigned to Company A corresponding to node K 662. Although not shown, fifth graph edge 614 may be directly traversable to another group type node (not shown) corresponding to the Company B client. Third graph edge 610 may be directly traversable to another group type node (not shown) corresponding to a group of users with the “Title 1” standard job title. Second graph edge 608 may be directly traversable to another group type node (not shown) corresponding to a group of organization members having the “Function 5” job function. First graph edge 606 may be directly traversable to another group type node (not shown) corresponding to members of the organization in the “Alpha” department.

Node G 616 includes second organizational member identity 618 (“Tom C”). Node G 616 includes sixth graph edge 620, which defines the department (“Beta”) that the second organizational member belongs to; seventh graph edge 622, which defines the job function (“Function 1”) for the second organizational member; eighth graph edge 624, which defines the standard job title (“Title 2”) for the second organizational member; ninth graph edge 626, which defines a team (“Group Team X: Team Name 1”) that the second organizational member is a member of; tenth graph edge 628, which defines a project (“Project 1”) that the second organizational member is assigned to; and eleventh graph edge 630, which defines a client (“Company A”) that the second organizational member is assigned projects for. Eleventh graph edge 630 is directly traversable to node K 662, as eleventh graph edge 630 identifies the second organizational member as being assigned to projects for Company A. The remainder of the edges of node G 616 may also be traversable to other group nodes that are not shown in FIG. 6 but that may be included in the organizational graph.

Node H 632 includes third organizational member identity 632 (“Jack W”). Node H 632 includes twelfth graph edge 636, which defines the department (“Gamma”) that the third organizational member belongs to; thirteenth graph edge 638, which defines the job function (“Function 6”) for the third organizational member; fourteenth graph edge 640, which defines the standard job title (“Title 2”) for the third organizational member; fifteenth graph edge 642, which defines a project (“Project 2”) that the third organizational member is assigned to; and sixteenth graph edge 644, which defines a client (“Company A”) that the third organizational member is assigned projects for. Sixteenth edge 644 is directly traversable to node K 662, as sixteenth graph edge 644 identifies the third organizational member as being assigned to projects for Company A. The remainder of the edges of node H 632 may also be traversable to other group nodes that are not shown in FIG. 6 but that may be included in the organizational graph.

Node I 646 includes the identity 648 of a first project (“Project 1”) associated with the organization. Node I 646 also includes seventeenth graph edge 650, which defines a client (“Company A”) that the first project is being worked on for; and eighteenth graph edge 652, which defines the status (“Ongoing”) of the first project. Seventeenth graph edge 650 is directly traversable to node K 662, as seventeenth graph edge 650 identifies the first project as being performed for Company A. Eighteenth graph edge 652 may also be traversable to other group nodes that are not shown in FIG. 6 but that may be included in the organizational graph. For example, eighteenth graph edge 652 may be directly traversable to an “ongoing project” node and to additional nodes downstream from that “ongoing project” node that define specific projects that are ongoing.

Node H 654 includes the identity 656 of a second project (“Project 2”) associated with the organization. Node H 654 also includes nineteenth graph edge 658, which defines a client (“Company A”) that the second project is being worked on for; and twentieth graph edge 660, which defines the status (“Ongoing”) of the second project. Nineteenth graph edge 658 is directly traversable to node K 662, as nineteenth graph edge 658 identifies the second project as being performed for Company A. Twentieth graph edge 660 may also be traversable to other group nodes that are not shown in FIG. 6 but that may be included in the organizational graph. For example, twentieth graph edge 660 may be directly traversable to an “ongoing project” node and to additional nodes downstream from that “ongoing project” node that define specific projects that are ongoing.

Node K 662 is the client group type node for the client “Company A”. Node K 662 includes information from the user nodes and project nodes that have edges leading into it. That information may be rendered graphically as edges by the organizational graph service, which may then be graphically traversed to the corresponding user nodes and project nodes and their edges. The edges of node K 662 may also be queried via natural language user input into an organizational graph application. In this example, node K 662 includes first group edge 664, which defines the identity of the first organizational member (“John T”), as well as the role (“Function 5”) of the first organizational member; second group edge 665, which defines the identity of the second organizational member (“Tom C”), as well as the role (“Function 1”) of the second organizational member; third group edge 668, which defines the third organizational member (“Jack W”), as well as the role (“Function 6”) of the third organizational member; fourth group edge 670, which defines the first project (“Project 1”) being performed for Company A by the organization, and the status (“Ongoing”) of that first project; and fifth edge 672, which defines the second project (“Project 2”) being performed for Company A by the organization, and the status (“Ongoing”) of that first project.

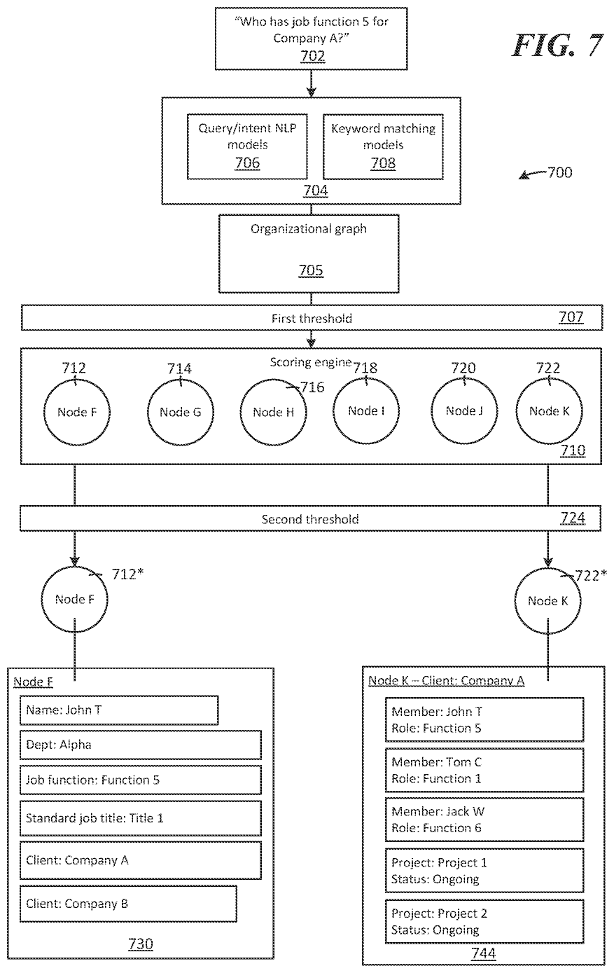

FIG. 7 illustrates a block diagram of an exemplary computing environment 700 for processing a natural language query by an organizational graph service in relation to the client portion of the organizational graph of FIG. 6. Computing environment 700 includes natural language user query 702, language models 704, organizational graph 705, first threshold value 707, scoring engine 710, second threshold value 724, and nodes for which query match scores have met or exceeded second threshold 724. Those nodes are node F 712* and node K 722*.

Natural language user query 702 includes the input: “Who has job function 5 for Company A?” Natural language query 702 may be received via a search interface of an organizational graph application associated with the organizational graph service. In additional examples, natural language user query 702 may be received via a different application (e.g., an email application, a contacts application) that may utilize an API to tie into the organizational graph service.

Natural language user query 702 may be processed by the organizational graph service, and specifically, by one or more language models, such as language models 704. Language models 704 may include query/intent natural language processing models 706 and keyword matching models 708, although more, fewer, and/or alternative models may be utilized by the organizational graph service to process natural language input queries. Query/intent natural language processing models 706 may comprise one or more machine learning models that have been trained to identify an intent type of queries provided to the organizational graph service. Examples of intent types that may be identified via processing by query/intent natural language processing models 706 may include “identify user”, “identify users”, “identify team”, “identify teams”, and “identify client”, among others. The intent types that query/intent natural language processing models 706 have been trained to identify may correspond to node types that are included in organizational graphs. In some examples, query intent natural language processing models 706 may comprise one or more embedding models (e.g., BERT, ELMo). In other examples, query/intent natural language processing models 406A may comprise a RNN model, a LSTM model, and/or a GRU model. In some examples a nearest neighbor model (e.g., KNN) may be utilized to determine similarity scores between embeddings.

In addition or alternatively to processing natural language user query 702 with query/intent natural language processing models 706, natural language user query 702 may be processed by one or more keyword matching models, such as keyword matching models 708. Keyword matching models 708 may match one or more words or phrases in natural language user query 702 to one or more words or phrases in one or more nodes of organizational graph 705. Organizational graph 705 comprises a plurality of nodes corresponding to all or a portion of an organizational graph.

A score may be generated for nodes in the organizational graph (e.g., organizational graph 705) based on the processing performed by query/intent natural language processing models 706 and/or keyword matching models 708. For example, a first score may be determined based on how closely an intent type identified via query/intent natural language processing models 706 matches a node type in organizational graph 705. A second score may be determined based on how closely a keyword or phrase in natural language user query 702 matches the corresponding word or phrase in a node (e.g., in an edge of a node) in organizational graph 705. In additional examples, if a first intent type corresponding to a node type is identified to a threshold degree of accuracy (e.g., a score for an intent type and corresponding node type meets a threshold score as determined via query/intent natural language processing models 706), keyword matching models 708 may only be applied on natural language user query 702 to match keywords or phrases of nodes corresponding to that type. Thus, by first identifying relevant intent types and their corresponding node types, processing costs may be greatly reduced in that keyword matching models 408A need only be applied to a smaller subset of nodes and their edges.

In this example, query/intent natural language processing models 706 may have identified node F 712 (node 602 in FIG. 6), node G 714 (node 616 in FIG. 6), node H 716 (node 632 in FIG. 632), node I 718 (node 646 in FIG. 6), node J 720 (node 654 in FIG. 6), and node K 722 (node 662 in FIG. 6) as meeting or exceeding first threshold value 707 of similarity to an intent type of natural language query 702. Keyword matching models 708 may then be applied to each of those nodes as illustrated by scoring engine 710, and a keyword or phrase matching score for each of those nodes may be determined. If the keyword or phrase matching score meets or exceeds second threshold value 724, the nodes corresponding to that score may be surfaced or otherwise highlighted or emphasized in a graphical user interface (e.g., an organizational graph user interface) in response to the user query. Thus, in this example, the scores for node F 712* and node K 722* meet or exceed threshold 724, and those nodes, or information included in those nodes may be surfaced. A user may interact with (e.g., click with a mouse, hover a cursor over, provide touch input relative to) a node that is surfaced, and additional information included in that node may be caused to be surfaced, as illustrated by node F 712* and corresponding additional information 730, and node K 722* and corresponding additional information 744.

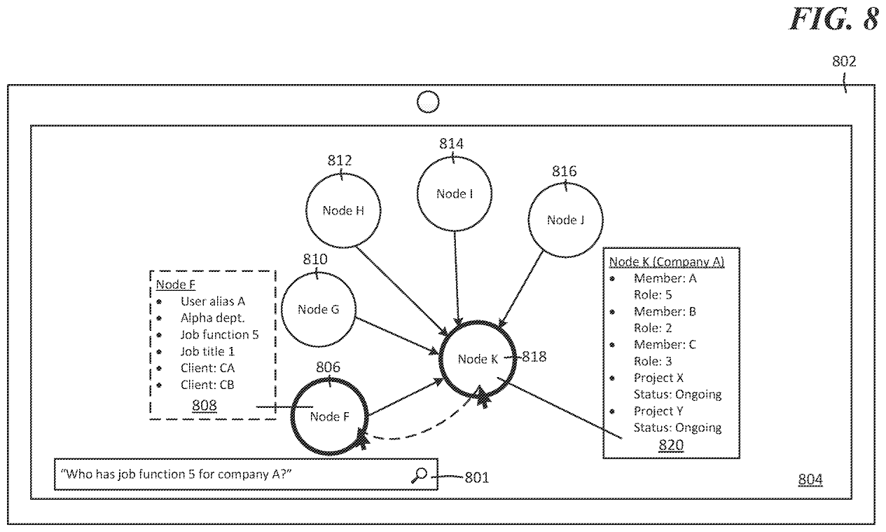

The organizational graph service may surface search results to user queries via a variety of mechanisms. In some examples, the organizational graph service may surface one or more top ranked (e.g., based on scoring described above in relation to FIG. 4A and FIG. 7) node names (e.g., group name, user name, team name) or descriptors. For example, one or more top ranked group names, user names, and/or team names may be surfaced via a textual user interface element, an electronic message, and/or an audio output from a computing device. In some examples, the surfaced search results may be interacted with (e.g., via cursor hover, via touch input, via selection of a link, via verbal/audio input), and that interaction may cause additional information associated with an interacted with search result to be surfaced. In some examples, interaction with a search result may cause display of a graph view of one or more top ranked search results, such as displayed in FIG. 8. In other examples, a graph view may be immediately displayed (e.g., not require interaction with a search result).

FIG. 8 illustrates an exemplary graphical user interface 804 for graphically traversing the client portion of the organizational graph of FIG. 6. Graphical user interface 804 is displayed on computing device 802. Graphical user interface 804 may be rendered in an organizational graph application after the organizational graph service receives and processes natural language user query 702 from FIG. 7.

Graphical user interface 804 includes node F 806, node G 810, node H 812, node I 814, node J 816, and node K 818. Nodes F 806 and K 818 are graphically emphasized (e.g., bolded, highlighted, different color) on user interface 804 because they are the nodes of the client portion of the organizational graph that were determined to have scores that meet or exceed the second threshold value for the user query (e.g., natural language user query 702). In this example, the user query is received via search box 801, although other query mechanisms (e.g., verbal search query, text query to digital assistant) may be utilized according to the systems sand methods described herein.

In this example, a user provides input relative to node K 818 by hovering a cursor, clicking on, or otherwise interacting with node K 818. As a result, window 820 is caused to be displayed, which provides information about the edges that are included in node K 818. Specifically, window 820 states “Node K (Company A)” and “Member: A” “role: 5”, “Member: B” “role:2”, “Member: C” “Role: 3”, “Project X” “Status: Ongoing”, “Project Y” “Status: Ongoing”. Another interaction is then received in relation to node F 806, which causes window 808 to be displayed. Window 808 provides information about edges that are included in node F 806. Specifically, window 808 states “Node F” and includes “User alias A”, “Alpha dept.”, “Job function 5”, “Job title 1”, “Client: CA”, and “Client: CB”. As discussed in relation to FIG. 6, the Company A (e.g., “Client: CA”) information of node F 806 may be directly traversed as an edge to node K 818.

The other nodes displayed on user interface 804 may also be interacted with by a user and, in response, information associated with the nodes may be displayed in a same or similar fashion as illustrated and described in relation to node K 818 and window 820, and node F 806 and window 808.

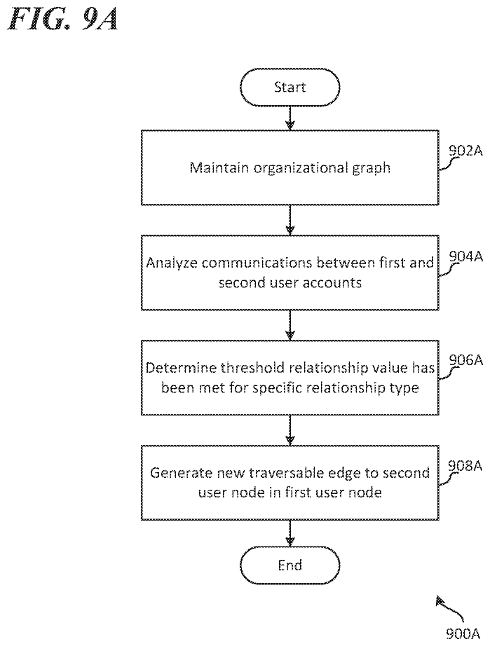

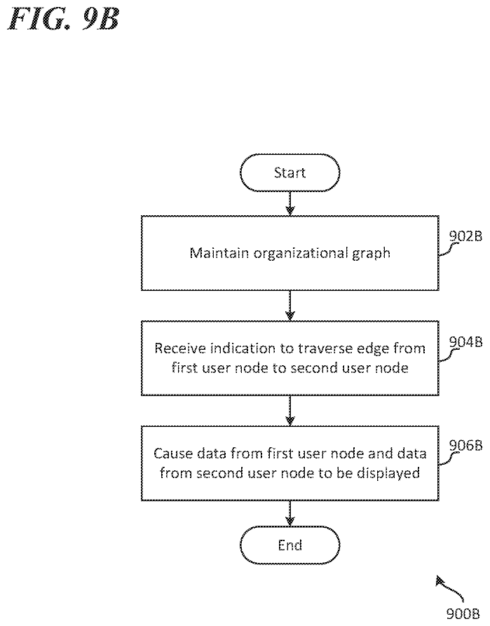

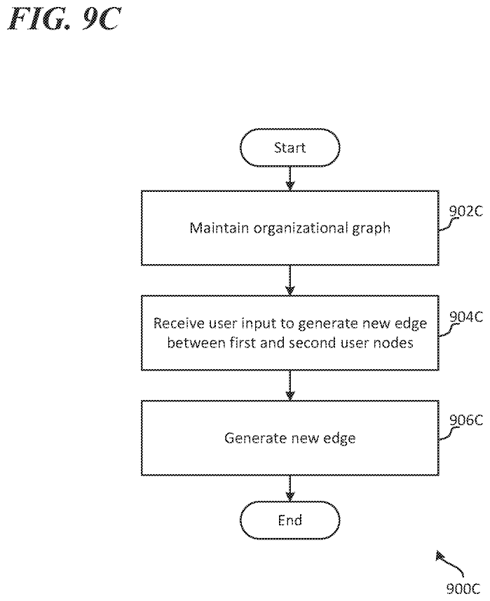

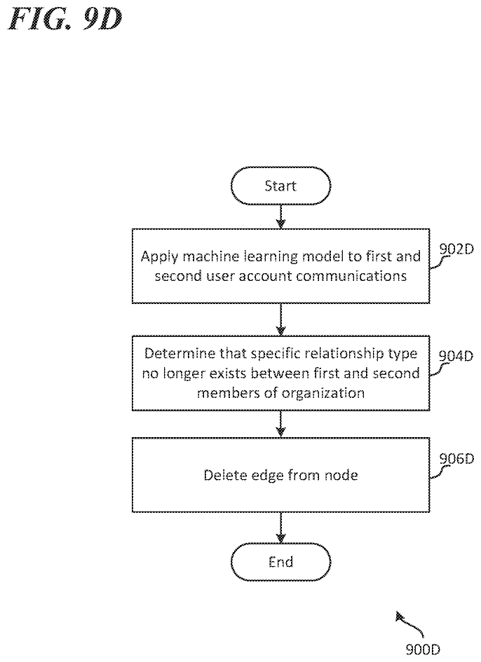

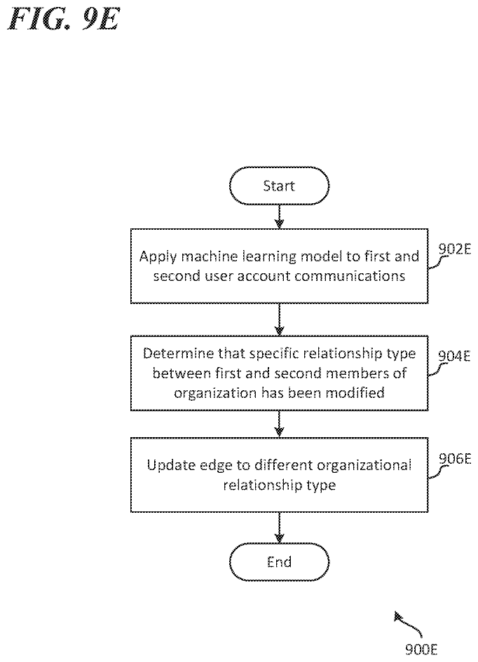

FIG. 9A is an exemplary method 900A for generating a new implicitly identified edge in an organizational graph. The method 900A begins at a start operation and flow moves to operation 902A.

At operation 902A an organizational graph is maintained. The organizational graph may be maintained by an organizational graph service. The organizational graph may comprise a first user node comprising an identity of a first user account of a first member of an organization, and a first plurality of edges. Each of the first plurality of edges may provide a traversable relationship between the first user node and at least one other node of the organizational graph. The organizational graph may further comprise a second user node comprising an identity of a second user account of a second member of the organization, and a second plurality of edges. Each of the second plurality of edges may provide a traversable relationship between the second user node and at least one other node of the organizational graph.

From operation 902A flow continues to operation 904A where a plurality of electronic communications between the first user account and the second user account are analyzed. The plurality of electronic communications may comprise one or more of email communications, instant messaging communications, direct electronic messages, SMS messages, electronic meeting communications, and other suitable electronic communications. In some examples, the analysis may comprise determining a number of electronic communications that include the first user account and the second user account over a specified period of time. In additional examples, the analysis may comprise determining a duration of time that the first user account and second user account spent in meetings together. In additional examples, the organizational graph service may analyze the content of the electronic communications and classify the communications based on that analysis. For example, the organizational graph service may analyze the content of emails sent between the first user account and the second user account and analyze the body of the emails, the subject line of the emails, the identity of other user accounts included on those emails, and/or documents attached to or linked by those emails. In other examples, the organizational graph service may transcribe audio from electronic meetings and analyze the transcriptions to classify portions of the meetings as being related to one or more topics, projects, or other organizational classification types.

From operation 904A flow continues to operation 906A where a determination is made based on the analysis that a threshold relationship value has been met for a specific organizational relationship type of a plurality of organizational relationship types. The specific organizational relationship type may be non-hierarchical and relate to a specific team of the organization. In other examples, the specific organizational relationship type may comprise a role type, a job title type, a function type, a client assignment type, a geographic location type, a department type, a project type, or a project status type. In some examples, the organization that the organizational graph is maintained for may customize its own organizational relationship types. In additional examples, different organizational relationship types may have different associated threshold relationship values.

From operation 906A flow continues to operation 908A where a new edge of the specific organizational relationship type is generated in the first node based at least on the determination. The new edge may be traversable to the second user node. In some examples, a new edge of the specific organizational relationship type may also be generated in the second node based on the determination. The new edge may be traversable via a natural language user query and/or via a graphical user interface of an organizational graph application.

From operation 912A flow moves to an end operation and the method 900A ends.

FIG. 9B is an exemplary method 900B for traversing an organizational graph. The method 900B begins at a start operation and flow moves to operation 902B.

At operation 902B an organizational graph is maintained. The organizational graph may be maintained by an organizational graph service. The organizational graph may comprise a first user node comprising an identity of a first user account of a first member of an organization, and a first plurality of edges. Each of the first plurality of edges may provide a traversable relationship between the first user node and at least one other node of the organizational graph. The organizational graph may further comprise a second user node comprising an identity of a second user account of a second member of the organization, and a second plurality of edges. Each of the second plurality of edges may provide a traversable relationship between the second user node and at least one other node of the organizational graph. In examples, a first one of the plurality of edges in the first user node may be associated with a specific organizational relationship type that is traversable to a first one of the plurality of edges in the second user node that is also associated with the specific organizational relationship type. Those edges may have been implicitly identified by the organizational graph service, and subsequently generated after affirmative user input by an administrative user of the organization. In other examples, those edges may have been explicitly identified and added to the organizational graph via user input by an administrative user of the organization.

From operation 902B flow continues to operation 904B where an indication to traverse the first one of the plurality of edges in the first user node to the first one of the plurality of edges in the second user node is received. The indication may comprise a natural language user query into an organizational graph application or a different application that utilizes an API to tie into the organizational graph service. In other examples, the indication may comprise an input into a graphical nodal display of the organizational graph (e.g., traversing the displayed organizational graph in the organizational graph application).

From operation 904B flow continues to operation 906B where data from the first user node and data from the second user node is caused to be displayed based on the received indication. The data may include group identity information, user identity information, user account identity information, edge information, and/or organizational relationship information encompassed in node edges.

From operation 906B flow continues to an end operation and the method 900B ends.

FIG. 9C is an exemplary method 900C for generating a new edge in an organizational graph based on receiving explicit user input. The method 900C begins at a start operation and flow moves to operation 902C.

At operation 902C an organizational graph is maintained. The organizational graph may be maintained by an organizational graph service. The organizational graph may comprise a first user node comprising an identity of a first user account of a first member of an organization, and a first plurality of edges. Each of the first plurality of edges may provide a traversable relationship between the first user node and at least one other node of the organizational graph. The organizational graph may further comprise a second user node comprising an identity of a second user account of a second member of the organization, and a second plurality of edges. Each of the second plurality of edges may provide a traversable relationship between the second user node and at least one other node of the organizational graph.

From operation 902C flow continues to operation 904C where a user input to generate a new edge between the first user node and the second user node is received from an administrative user account of the organization. That is, only certain organizational users (e.g., users with administrative user accounts) may have permissions to modify an organizational graph for an organization. The user input may comprise an indication of a specific organizational relationship type of the plurality of relationship types. In some examples, the specific organizational relationship may be non-hierarchical. The plurality of relationship types may comprise one or more of a team type, a role type, a job title type, a function type, a client assignment type, a geographic location type, a department type, a project type, or a project status type. In some examples, the organization that the organizational graph is maintained for may customize its own organizational relationship types.

From operation 904C flow continues to operation 906C where a new edge of the specific organizational relationship type is generated in the first user node based on the user input. The new edge may be traversable to the second user node. In examples, a new edge of the specific organizational relationship type may also be generated in the second user node based on the user input. The new edge in the second user node may be traversable to the first user node.

From operation 910B flow moves to an end operation and the method 900B ends.

FIG. 9D is an exemplary method 900D for deleting an edge from an organizational graph based on determining that a relationship no longer exists between members of an organization or has substantially declined. The method 900D begins at a start operation and flow moves to operation 902D.

At operation 902D a machine learning model is applied to a plurality of electronic communications between a first user account and a second user account. The first user account may be associated with a first user node in an organizational graph. The second user account may be associated with a second user node in the organizational graph. In examples, an edge in the first user node, having a specific organizational relationship type, may be traversed to an edge in the second user node, also having the specific organizational relationship type. The machine learning model may be trained to classify user accounts as belonging to same organizational entities (e.g., teams, groups, roles, job functions) based on frequency of electronic communications between user accounts, recency of electronic communications between user accounts, duration of electronic communications between user accounts, or frequency, recency, or duration of types of electronic communications between user accounts. In additional examples, the machine learning model may comprise one or more language vector embedding models (e.g., BERT, ELMo). In other examples, the machine learning model may comprise a RNN model, a LSTM model, and/or a GRU model. In some examples, a nearest neighbor model (e.g., KNN) may be utilized to determine similarity scores between embeddings (e.g., similarity of document classification embeddings).

From operation 902D flow continues to operation 904D where a determination is made, based on the application of the machine learning model, that the specific organizational relationship type between the first user account and the second user account no longer exists or has substantially declined. For example, a determination may be made that a member corresponding to the first user account is no longer on a same team as a member corresponding to the second user account. In some instances, these members may still exchange communications, but at a frequency that is substantially less than when they were members of the same team.

From operation 904D flow continues to operation 906D where the edge corresponding to the first user account is deleted. In some examples, rather than making the determination that an edge should be deleted based on analyzing electronic communications between the two user accounts, the organizational graph service may make that determination based on analyzing electronic communications between the first user account and one or more other user accounts (e.g., the first user account and a third user account, the first user account and a fourth user account). In still additional examples, the organizational graph service may make the determination that an edge should be deleted based on analyzing electronic documents associated with one or both user accounts. For example, if the organizational graph determines based on analyzing electronic documents from the first user account that that the organizational member corresponding to the first user account no longer belongs to a team or no longer works on a specific project, an edge corresponding to that team or specific project may be deleted from the first user node.

From operation 904D flow moves to an end operation and the method 900D ends.

FIG. 9E is an exemplary method 900E for updating an edge of an organizational graph based on determining that a relationship between members of an organization has been modified. The method 900E begins at a start operation and flow continues to 902E.

At operation 902E a machine learning model is applied to a plurality of electronic communications between a first user account and a second user account. The first user account may be associated with a first user node in an organizational graph. The second user account may be associated with a second user node in the organizational graph. In examples, an edge in the first user node, having a specific organizational relationship type, may be traversed to an edge in the second user node, also having the specific organizational relationship type. The machine learning model may be trained to classify user accounts as belonging to same organizational entities (e.g., teams, groups, roles, job functions) based on frequency of electronic communications between user accounts, recency of electronic communications between user accounts, duration of electronic communications between user accounts, or frequency, recency or duration of types of electronic communications between user accounts. In additional examples, the machine learning model may comprise one or more language vector embedding models (e.g., BERT, ELMo). In other examples, the machine learning model may comprise a RNN model, a LSTM model, and/or a GRU model. In some examples, a nearest neighbor model (e.g., KNN) may be utilized to determine similarity scores between embeddings (e.g., similarity of document classification embeddings).

From operation 902D flow continues to operation 904D where a determination is made, based on the application of the machine learning model, that the specific organizational relationship type between the first user account and the second user account has been modified. For example, the first user account and the second user account may have previously been assigned the same organizational team and a same client project. A determination may be made that the member of the organization corresponding to the first user account no longer works on that first project and/or the that the member of the organization corresponding to the first user account has a different role on the team.

From operation 904D flow continues to operation 906D where at least the edge in the first user account that is traversable to the second user account is updated to a different organizational relationship type that reflects the determined modification. In some examples, rather than making the determination that an edge should be modified based on analyzing electronic communications between the two user accounts, the organizational graph service may make the determination based on analyzing electronic communications between the first user account and one or more other user accounts (e.g., the first user account and a third user account, the first user account and a fourth user account). In still other examples, the organizational graph service may make the determination that an edge should be modified based on analyzing electronic documents associated with one or both user accounts. For example, if the organizational graph determines based on analyzing electronic documents from the first user account that the organizational member corresponding to the first user is working on a different project for the team, an edge corresponding to that specific project may be modified.

From operation 906D flow moves to an end operation and the method 900D ends.

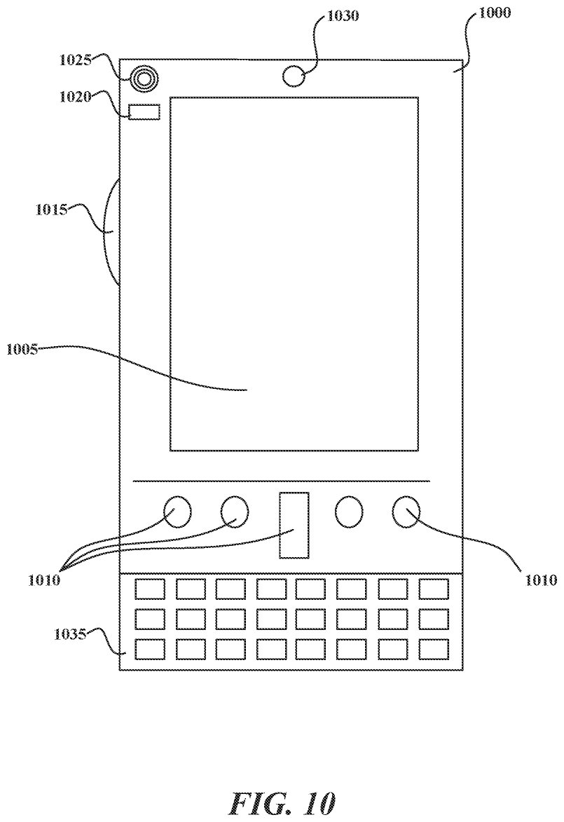

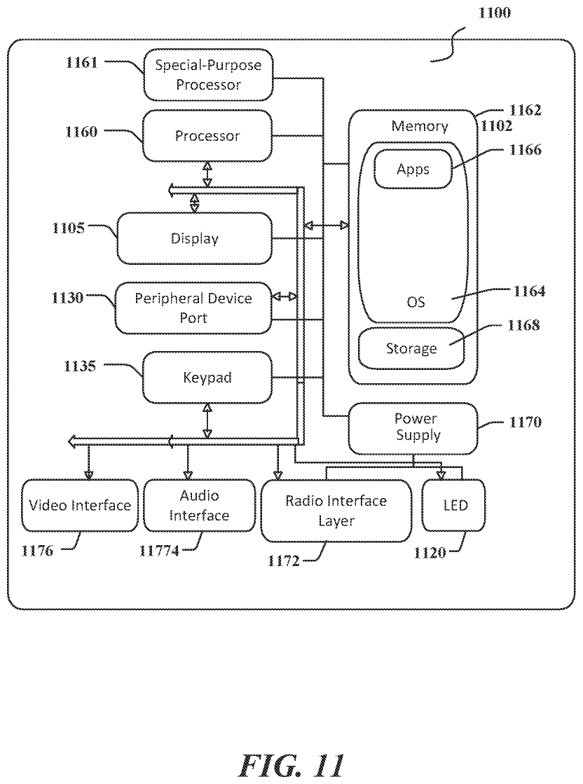

FIGS. 10 and 11 illustrate a mobile computing device 1000, for example, a mobile telephone, a smart phone, wearable computer (such as smart eyeglasses), a tablet computer, an e-reader, or a laptop computer, with which embodiments of the disclosure may be practiced. With reference to FIG. 10, one aspect of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display). If included, an optional side input element 1015 allows further user input. The side input element 1015 may be a rotary switch, a button, or any other type of manual input element. In alternative aspects, mobile computing device 1000 may incorporate more or fewer input elements. For example, the display 1005 may not be a touch screen in some embodiments. In yet another alternative embodiment, the mobile computing device 1000 is a portable phone system, such as a cellular phone. The mobile computing device 1000 may also include an optional keypad 1035. Optional keypad 1035 may be a physical keypad or a “soft” keypad generated on the touch screen display. In various embodiments, the output elements include the display 1005 for showing a graphical user interface (GUI), a visual indicator 1020 (e.g., a light emitting diode), and/or an audio transducer 1025 (e.g., a speaker). In some aspects, the mobile computing device 1000 incorporates a vibration transducer for providing the user with tactile feedback. In yet another aspect, the mobile computing device 1000 incorporates input and/or output ports, such as an audio input (e.g., a microphone jack), an audio output (e.g., a headphone jack), and a video output (e.g., a HDMI port) for sending signals to or receiving signals from an external device.

FIG. 11 is a block diagram illustrating the architecture of one aspect of a mobile computing device. That is, the mobile computing device 1100 can incorporate a system (e.g., an architecture) 1102 to implement some aspects. In one embodiment, the system 1102 is implemented as a “smart phone” capable of running one or more applications (e.g., browser, e-mail, calendaring, contact managers, messaging clients, games, and media clients/players). In some aspects, the system 1102 is integrated as a computing device, such as an integrated personal digital assistant (PDA) and wireless phone.

One or more application programs 1166 may be loaded into the memory 1162 and run on or in association with the operating system 1164. Examples of the application programs include phone dialer programs, e-mail programs, personal information management (PIM) programs, word processing programs, spreadsheet programs, Internet browser programs, messaging programs, and so forth. The system 1102 also includes a non-volatile storage area 1168 within the memory 1162. The non-volatile storage area 1168 may be used to store persistent information that should not be lost if the system 1102 is powered down. The application programs 1166 may use and store information in the non-volatile storage area 1168, such as e-mail or other messages used by an e-mail application, and the like. A synchronization application (not shown) also resides on the system 1102 and is programmed to interact with a corresponding synchronization application resident on a host computer to keep the information stored in the non-volatile storage area 1168 synchronized with corresponding information stored at the host computer. As should be appreciated, other applications may be loaded into the memory 1162 and run on the mobile computing device 1100, including instructions for providing and operating a digital assistant computing platform.

The system 1102 has a power supply 1170, which may be implemented as one or more batteries. The power supply 1170 might further include an external power source, such as an AC adapter or a powered docking cradle that supplements or recharges the batteries.

The system 1102 may also include a radio interface layer 1172 that performs the function of transmitting and receiving radio frequency communications. The radio interface layer 1172 facilitates wireless connectivity between the system 702 and the “outside world,” via a communications carrier or service provider. Transmissions to and from the radio interface layer 1172 are conducted under control of the operating system 1164. In other words, communications received by the radio interface layer 1172 may be disseminated to the application programs 1166 via the operating system 1164, and vice versa.

The visual indicator 1020 may be used to provide visual notifications, and/or an audio interface 1174 may be used for producing audible notifications via the audio transducer 1025. In the illustrated embodiment, the visual indicator 1020 is a light emitting diode (LED) and the audio transducer 1025 is a speaker. These devices may be directly coupled to the power supply 1170 so that when activated, they remain on for a duration dictated by the notification mechanism even though the processor 1160 and other components might shut down for conserving battery power. The LED may be programmed to remain on indefinitely until the user takes action to indicate the powered-on status of the device. The audio interface 1174 is used to provide audible signals to and receive audible signals from the user. For example, in addition to being coupled to the audio transducer 1025, the audio interface 1174 may also be coupled to a microphone to receive audible input, such as to facilitate a telephone conversation. In accordance with embodiments of the present disclosure, the microphone may also serve as an audio sensor to facilitate control of notifications, as will be described below. The system 1102 may further include a video interface 1176 that enables an operation of an on-board camera 1030 to record still images, video stream, and the like.

A mobile computing device 1100 implementing the system 1102 may have additional features or functionality. For example, the mobile computing device 1100 may also include additional data storage devices (removable and/or non-removable) such as, magnetic disks, optical disks, or tape. Such additional storage is illustrated in FIG. 11 by the non-volatile storage area 1168.

Data/information generated or captured by the mobile computing device 1100 and stored via the system 1102 may be stored locally on the mobile computing device 1100, as described above, or the data may be stored on any number of storage media that may be accessed by the device via the radio interface layer 1172 or via a wired connection between the mobile computing device 1100 and a separate computing device associated with the mobile computing device 1100, for example, a server computer in a distributed computing network, such as the Internet. As should be appreciated such data/information may be accessed via the mobile computing device 1100 via the radio interface layer 1172 or via a distributed computing network. Similarly, such data/information may be readily transferred between computing devices for storage and use according to well-known data/information transfer and storage means, including electronic mail and collaborative data/information sharing systems.

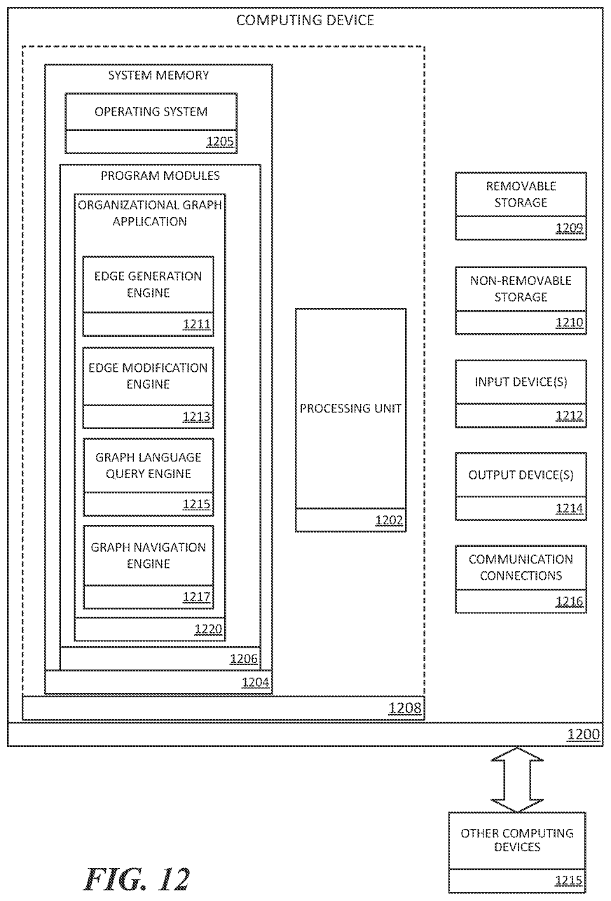

FIG. 12 is a block diagram illustrating physical components (e.g., hardware) of a computing device 1200 with which aspects of the disclosure may be practiced. The computing device components described below may have computer executable instructions for maintaining and interacting with organizational graphs. In a basic configuration, the computing device 1200 may include at least one processing unit 1202 and a system memory 1204. Depending on the configuration and type of computing device, the system memory 1204 may comprise, but is not limited to, volatile storage (e.g., random access memory), non-volatile storage (e.g., read-only memory), flash memory, or any combination of such memories. The system memory 1204 may include an operating system 1205 suitable for running one or more organizational graph applications and/or productivity applications. The operating system 1205, for example, may be suitable for controlling the operation of the computing device 1200. Furthermore, embodiments of the disclosure may be practiced in conjunction with a graphics library, other operating systems, or any other application program and is not limited to any particular application or system. This basic configuration is illustrated in FIG. 12 by those components within a dashed line 1208. The computing device 1200 may have additional features or functionality. For example, the computing device 1200 may also include additional data storage devices (removable and/or non-removable) such as, for example, magnetic disks, optical disks, or tape. Such additional storage is illustrated in FIG. 12 by a removable storage device 1209 and a non-removable storage device 1210.

As stated above, a number of program modules and data files may be stored in the system memory 1204. While executing on the processing unit 1202, the program modules 1206 (e.g., organizational graph application 1220) may perform processes including, but not limited to, the aspects, as described herein. For example, edge generation engine 1211 may perform one or more operations associated with analyzing (e.g., applying machine learning models to) electronic communications and electronic documents, determining based on that analysis that a relationship threshold has been met between two nodal entities, and generating a new edge based on that determination. Edge modification engine 1211 may perform one or more operations associated with analyzing (e.g., applying machine learning models to) electronic communications and electronic documents, determining based on that analysis that a relationship type between two nodal entities has been modified, and modifying edge relationship data based on that determination. Graph language query engine 1215 may perform one or more operations associated with determining an intent associated with a natural language graph query, identifying one or more nodes that match that intent, applying a keyword or phrase matching model to the natural language query and the one or more nodes, and surfacing relevant nodal information. Graph navigation engine 1217 may perform one or more operations associated with displaying nodes and graphical edge connections in a user interface and providing mechanisms for users to graphically traverse nodes via the displayed edge connections.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1200 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1200 may also have one or more input device(s) 1212 such as a keyboard, a mouse, a pen, a sound or voice input device, a touch or swipe input device, etc. The output device(s) 1214 such as a display, speakers, a printer, etc. may also be included. The aforementioned devices are examples and others may be used. The computing device 1200 may include one or more communication connections 1216 allowing communications with other computing devices 1250. Examples of suitable communication connections 1216 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1204, the removable storage device 1209, and the non-removable storage device 1210 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1200. Any such computer storage media may be part of the computing device 1200. Computer storage media does not include a carrier wave or other propagated or modulated data signal. Similarly, computer storage device does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

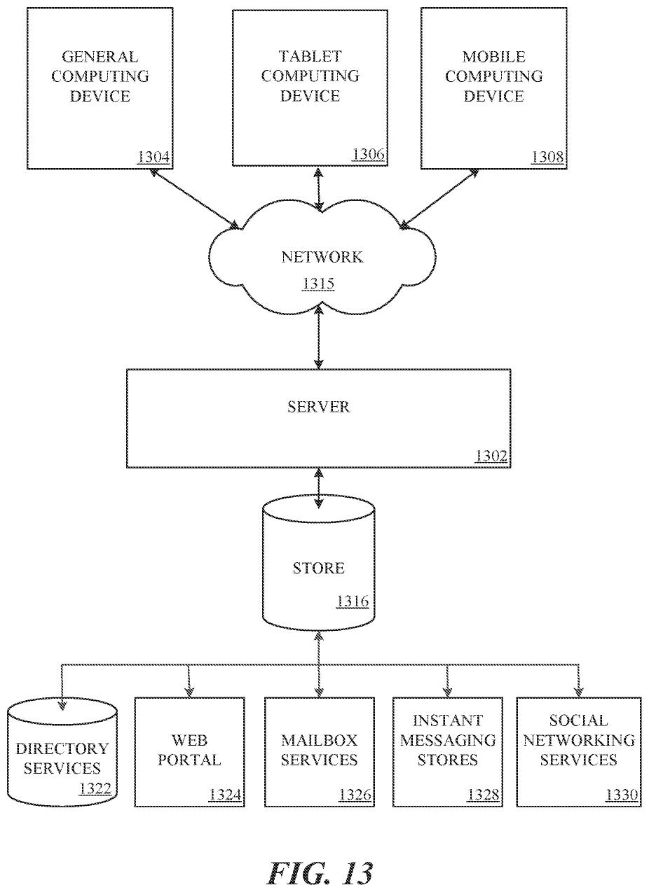

FIG. 13 illustrates one aspect of the architecture of a system for processing data received at a computing system from a remote source, such as a personal/general computer 1304, tablet computing device 1306, or mobile computing device 1308, as described above. Content displayed at server device 1302 may be stored in different communication channels or other storage types. For example, various documents may be stored using a directory service 1322, a web portal 1324, a mailbox service 1326, an instant messaging store 1328, or a social networking site 1330. The program modules 1206 may be employed by a client that communicates with server device 1302, and/or the program modules 1206 may be employed by server device 1302. The server device 1302 may provide data to and from a client computing device such as a personal/general computer 1304, a tablet computing device 1306 and/or a mobile computing device 1308 (e.g., a smart phone) through a network 1315. By way of example, the computer systems described herein may be embodied in a personal/general computer 1304, a tablet computing device 1306 and/or a mobile computing device 1308 (e.g., a smart phone). Any of these embodiments of the computing devices may obtain content from the store 1316, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method comprising:
maintaining an organizational graph comprising:
a first user node comprising an identity of a first user account of a first member of an organization, and a first plurality of edges, wherein each of the first plurality of edges provides a traversable relationship between the first user node and at least one other node of the organizational graph; and
a second user node comprising an identity of a second user account of a second member of the organization, and a second plurality of edges, wherein each of the second plurality of edges provides a traversable relationship between the second user node and at least one other node of the organizational graph;
analyzing a plurality of electronic communications between the first user account and the second user account;
determining, based on the analysis, that a threshold relationship value has been met for a specific organizational relationship type of a plurality of organizational relationship types; and
generating, in the first user node based at least on the determination, a new edge of the organizational graph, wherein the new edge is associated with the specific organizational relationship type and is traversable to the second user node.

2. The computer-implemented method of claim 1, wherein:
each of the first plurality of edges and each of the second plurality of edges is associated with at least one of the plurality of organizational relationship types.

3. The computer-implemented method of claim 1, further comprising:
receiving an indication to traverse the new edge; and
causing, based on the received indication, data from the first user node and data from the second user node to be displayed.

4. The computer-implemented method of claim 3, wherein receiving the indication to traverse the new edge comprises:
receiving a natural language query;
processing the natural language query with a natural language processing engine; and
determining that the natural language query exceeds a threshold match score for the new edge.

5. The computer-implemented method of claim 3, further comprising:
causing the first user node to be displayed in an organizational graph application user interface, and wherein receiving the indication to traverse the new edge comprises receiving a selection of a display element corresponding to the new edge.

6. The computer-implemented method of claim 1, wherein:
the specific organizational relationship type is non-hierarchical; and
the specific organizational relationship type relates to a specific team of the organization.

7. The computer-implemented method of claim 6, wherein:
prior to the determination being made that the threshold relationship value has been met, the organizational graph further included a group node for the specific team of the organization; and
the group node is updated, upon the determination being made that the threshold relationship value has been met, to include information from the first user node and the second user node.

8. The computer-implemented method of claim 6, further comprising:
determining that the organizational graph does not include a first group node for the specific team of the organization; and
adding, upon determining that the relationship value has been met, a group node including information from the first user node and the second user node to the organizational graph.

9. The computer-implemented method of claim 1, wherein analyzing the plurality of electronic communications between the first user account and the second user account comprises analyzing at least one of: a duration of time of electronic meetings attended jointly by the first user account and the second user account; a number of electronic communications jointly including the first user account and the second user account; and a frequency of electronic communications jointly including the first user account and the second user account.

10. The computer-implemented method of claim 1, wherein analyzing the plurality of electronic communications comprises applying a content classification machine learning model to content of at least one of the plurality of communications.

11. The computer-implemented method of claim 10, wherein the content classification machine learning model has been trained to classify textual content as being related to one or more teams of the organization.

12. The computer-implemented method of claim 10, wherein the content classification machine learning model has been trained to classify textual content as being related to one or more projects of the organization.

13. A system for generating a new edge in an organizational graph, comprising:
a memory for storing executable program code; and
a processor, functionally coupled to the memory, the processor being responsive to computer-executable instructions contained in the program code and operative to:
maintain the organizational graph, the organizational graph comprising:
a first user node comprising an identity of a first user account of a first member of an organization, and a first plurality of edges, wherein each of the first plurality of edges provides a traversable relationship between the first user node and at least one other node of the organizational graph; and
a second user node comprising an identity of a second user account of a second member of the organization, and a second plurality of edges, wherein each of the second plurality of edges provides a traversable relationship between the second user node and at least one other node of the organizational graph;
analyze a plurality of electronic communications between the first user account and the second user account;
determine, based on the analysis, that a threshold relationship value has been met for a specific organizational relationship type of a plurality of organizational relationship types; and
generate, in the first user node based at least on the determination, a new edge of the organizational graph, wherein the new edge is associated with the specific organizational relationship type and is traversable to the second user node.

14. The system of claim 13, wherein the processor is further responsive to the computer-executable instructions contained in the program code and operative to:
cause a notification to be surfaced to the first and second user accounts to confirm the specific organizational relationship type exists between the first member of the organization and the second member of the organization;
receive confirmation from the first and second user accounts; and
generate the new edge of the specific organizational relationship upon receiving the confirmation.

15. The system of claim 13, wherein the processor is further responsive to the computer-executable instructions contained in the program code and operative to:
generate, in the second user node based at least on the determination, a new edge of the specific organizational relationship type that is traversable to the first user node.

16. The system of claim 13, wherein the processor is further responsive to the computer-executable instructions contained in the program code and operative to:
receive an indication to traverse the new edge; and
cause, based on the received indication, data from the first user node and data from the second user node to be displayed.

17. The system of claim 16, wherein in receiving the indication to traverse the new edge, the processor is further responsive to the computer-executable instructions contained in the program code and operative to:
receive a natural language query;
process the natural language query with a natural language processing engine; and
determine that the natural language query exceeds a threshold match score for the new edge.

18. A computer-readable storage device comprising executable instructions that, when executed by a processor, assist with generating a new edge in an organizational graph, the computer-readable storage device including instructions executable by the processor for:
maintaining the organizational graph, the organizational graph comprising:
a first user node comprising an identity of a first user account of a first member of an organization, and a first plurality of edges, wherein each of the first plurality of edges provides a traversable relationship between the first node and at least one other node of the organizational graph; and
a second user node comprising an identity of a second user account of a second member of the organization, and a second plurality of edges, wherein each of the second plurality of edges provides a traversable relationship between the second user node and at least one other node of the organizational graph;
receiving a user input to generate a new edge between the first user node and the second user node, wherein the user input comprises an indication of a specific organizational relationship type of a plurality of organizational relationship types; and
generating, in the first user node based on the user input, a new edge of the organizational graph, wherein the new edge is associated with the specific organizational relationship type and is traversable to the second user node.

19. The computer-readable storage device of claim 18, wherein the instructions are further executable by the processor for:
applying a machine learning model to a plurality of electronic communications between the first user account and the second user account;
determining, based on the application of the machine learning model, that the specific organizational relationship type no longer exists between the first member of the organization and the second member of the organization; and
deleting, from the first user node, the new edge.

20. The computer-readable storage device of claim 18, wherein the instructions are further executable by the processor for:
applying a machine learning model to a plurality of electronic communications between the first user account and the second user account;
determining, based on the application of the machine learning model, that the specific organizational relationship type has been modified to a different organizational relationship type between the first member of the organization and the second member of the organization; and
updating the new edge to the different organizational relationship type.
